(19) United States
(12) Patent Application Publication
(10) Pub. No.: US 2025/0299421 A1
(43) Pub. Date: Sep. 25, 2025

(54) DATA PROCESSING SYSTEMS

(71) Applicant: Arm Limited, Cambridge (GB)

(72) Inventors: Roberto Lopez Mendez, Cambridge (GB); Daren Croxford, Swaffham Prior (GB); Mina Ivanova Dimova, Great Shelford (GB); Remy Pottier, Grenoble (FR)

(73) Assignee: Arm Limited, Cambridge (GB)

(21) Appl. No.: 18/611,359

(22) Filed: Mar. 20, 2024

(51) Int. Cl. G06T 15/08; G06T 15/00; G06T 15/06

(52) U.S. Cl. CPC G06T 15/08; G06T 15/005; G06T 15/06; G06T 2210/21

(57) ABSTRACT

A data processing system and method for performing processing relating to a scene represented by a set of one or more voxels. A data processor of the data processing system comprises an execution unit operable to execute instructions to perform data processing operations. A traversal unit of the data processing system is configured to traverse a hierarchical data structure with one or more leaf nodes comprising data relating to voxels. A traversal of the hierarchical data structure by the traversal unit is performed in response to the execution unit executing an instruction indicating that a traversal is to be performed.

### BACKGROUND

The technology described herein relates to data processing systems, and in particular to the operation of a data processor when processing a scene represented by a set of one or more voxels.

Voxels may be used when representing a three-dimensional (3D) scene which contains one or more elements, e.g. objects, of interest. Each voxel represents a volume in space (typically a cube), and has associated properties (e.g. colour, transparency, or other properties), for example corresponding to the element(s) occupying that volume.

For example, when creating a digital reconstruction of a ‘real world’ scene, elements of that scene may be ‘voxelized’ (converted into a voxel based representation). The voxel based representation may then be used to render and display those elements (for example as part of an extended reality (XR) application or medical visualisation) or otherwise used for analysing the scene (e.g. to identify hazards when performing autonomous driving).

The Applicant believes that there remains scope for improvements to efficiently handle voxel based representations of scenes.

### BRIEF DESCRIPTION OF THE DRAWINGS

A number of embodiments of the technology described herein will now be described by way of example only and with reference to the accompanying drawings, in which:

FIG. 1 shows a data processing system;

FIG. 2 shows a graphics processor comprising a traversal unit in embodiments of the technology described herein;

FIG. 3 shows an alternative arrangement for a graphics processor comprising a traversal unit in embodiments of the technology described herein;

FIG. 4 show in more detail a traversal unit in embodiments of the technology described herein;

FIGS. 5A to 5E illustrate data flow when triggering and performing a traversal in embodiments of the technology described herein;

FIG. 6 is a flowchart showing triggering and performing a traversal in embodiments of the technology described herein;

FIG. 7 is another flowchart showing triggering and performing a traversal in embodiments of the technology described herein;

FIG. 8 illustrates a hierarchical data structure which may be traversed in embodiments of the technology described herein, with leaf nodes that can contain data relating to one or more voxels;

FIG. 9 illustrates a hierarchical data structure which may be traversed in embodiments of the technology described herein, having leaf nodes which indicate that a further data structure is to be traversed to obtain data relating to one or more voxels;

FIGS. 10A and 10B illustrate a scene represented using one or more voxels, for which in embodiments of the technology described herein data may be provided in one or more leaf nodes, the voxels in FIG. 10A being axis-aligned, and the voxels in FIG. 10B not being axis-aligned; and

FIGS. 11A to 11D illustrate different types of leaf node comprising data relating to one or more voxels, in embodiments of the technology described herein.

Like reference numerals are used for like elements in the Figures where appropriate.

### DETAILED DESCRIPTION

In one embodiment, the technology described herein comprises a method of operating a data processing system when performing processing relating to a scene represented by a set of one or more voxels, the data processing system comprising:
a data processor, the data processor comprising an execution unit operable to (configured to) execute instructions to perform data processing operations; and
a traversal unit, for use when performing processing relating to a scene represented by a set of one or more voxels,
the traversal unit configured to traverse a hierarchical data structure representing a set of one or more voxels representing a scene, the hierarchical data structure comprising a plurality of nodes each associated with a respective volume within the scene, with one or more leaf nodes of the hierarchical data structure comprising data relating to one or more voxels that occupy the volume associated with the respective leaf node, to access data relating to one or more voxels representing the scene; and
the method comprising:
the execution unit, in response to executing an instruction indicating that a hierarchical data structure representing a set of one or more voxels representing a scene is to be traversed, causing the traversal unit to traverse the hierarchical data structure; and
the traversal unit, when traversing the hierarchical data structure, when a leaf node is encountered containing data relating to one or more voxels, triggering processing relating to said one or more voxels.

In another embodiment, the technology described herein comprises a data processing system configured to perform processing relating to a scene represented by a set of one or more voxels, the data processing system comprising:
a data processor, the data processor comprising an execution unit operable to (configured to) execute instructions to perform data processing operations; and
a traversal unit, for use when performing processing relating to a scene represented by a set of one or more voxels,
the traversal unit configured to traverse a hierarchical data structure representing a set of one or more voxels representing a scene, the hierarchical data structure comprising a plurality of nodes each associated with a respective volume within the scene, with one or more leaf nodes of the hierarchical data structure comprising data relating to one or more voxels that occupy the volume represented by a respective leaf node, to access data relating to one or more voxels representing the scene;
wherein the execution unit is configured to, in response to executing an instruction indicating that a hierarchical data structure representing a set of one or more voxels representing a scene is to be traversed, cause the traversal unit to traverse the hierarchical data structure; and
the traversal unit is configured to, when traversing a hierarchical data structure, when a leaf node is encountered containing data relating to one or more voxels, trigger processing related to said one or more voxels.

Accordingly, the technology described herein comprises a data processing system for handling (and method of operating a data processing system to handle) scenes represented by one or more voxels. In particular, this is done by providing a traversal unit (traversal circuit) which is configured to traverse (walk) a hierarchical data structure representing the voxels of a scene, and access data relating to voxels from the leaf nodes of the data structure. Traversal of the hierarchical data structure representing the voxels of a scene by the traversal unit is triggered when an execution unit of a data processor of the system (which may, for example, be executing a program requiring processing of the scene) executes an instruction indicating that a hierarchical data structure representing the voxels of a scene should be traversed.

In this regard the Applicant has recognised that, since voxels represent volumes in space, data relevant to voxels can be efficiently accessed using a hierarchical data structure (e.g. bounding volume hierarchy (BVH), a KD-tree, an Oct-tree, a binary space partitioning (BSP) tree, or other hierarchical data structure) which spatially sorts the voxel data. Furthermore, the Applicant has recognised that a hardware accelerator (traversal unit (circuit)) can be provided to perform traversal of a hierarchical data structure representing voxels of a scene, and that traversal of the hierarchical data structure representing voxels of a scene by the accelerator (traversal unit) can advantageously be triggered by way of a (single) instruction in a program being executed by the execution unit.

As noted above, the technology described herein is concerned with a data processing system configured to (and operated to) perform processing relating to a scene represented by a set of one or more voxels.

A (each) voxel representing the scene corresponds to a (three-dimensional) volume (for example, and in embodiments, a cube) in the scene (in the three-dimensional space of the scene), a (each) voxel (in an embodiment) corresponding to a single sampled volume (data point).

A (each) voxel may have one or more properties associated with it, which are indicative of (visual and/or non-visual) properties of the volume represented by the voxel. For example, one or more properties associated with a (each) voxel may comprise any of: colour (for example, in red, green, blue (RGB) format), transparency (alpha), texture (indicating for example any of a material, reflectivity, plenoptic function), motion vector, or other (non-visual) properties such as mass, density, strength or other (non-visual) properties.

A (each) voxel may have any suitable and desired size. For example, a (each) voxel could correspond to a same (smallest) sampling volume for the scene. However, it would equally be possible for voxels to vary in size, so as to vary the effective resolution at which (a region of, or an element (object) in) the scene is represented. For example voxel size may vary depending on position in the scene, for example with voxel(s) which are closer to a user's viewpoint being smaller than voxel(s) which are further away from a user's viewpoint. Voxel size may (additionally or alternatively) vary depending on the complexity of the region of the scene (the complexity of an element (object) in the scene) represented by the voxel(s), and/or depending on storage allocated (a memory footprint) to be used for representing the region of (element (object) in) the scene.

The scene for which processing is to be performed (and which is represented by one or more voxels) may be any suitable and desired three-dimensional (3D) scene. The scene may contain one or more elements of interest which are respectively represented by one or more voxels. In other words, a (each) voxel may represent (at least part of) an element within the scene.

The scene could, for example, correspond to (represent) an environment which could be outdoors, indoors, or any other physical environment (for example an environment relating to a human body as may be of interest for medical imaging and diagnostics, or an environment within a mechanical system (such as a machine) as may be of interest for mechanical imaging and diagnostics, or a geographical environment, or other environment or object to be analysed).

The scene may be static or could change dynamically. For example the scene may change dynamically as a viewpoint from which the scene is viewed changes, and/or as one or more elements of the scene change (for example, change shape, move, appear, disappear).

An element within the scene (which may be represented by one or more voxels) may comprise any suitable and desired element within a scene, for example a surface or an object. An element within the scene may be static or moving. Example surfaces (which may be represented by one or more voxels) include, walls, floors, ceilings, or other surfaces. Example objects (which may be represented by one or more voxels), in the case of an indoor or outdoor scene, include tables, chairs, plants, animals, people, automobiles, or other objects. Example objects (which may be represented by one or more voxels) in the case of a mechanical system may be mechanical components. Example objects (which may be represented by one or more voxels) in the case of a medical (biological) scene, may be biological structures imaged by a medical imaging system (for example ultrasound, scanning, computer tomography, endoscopy, or other medical imaging systems) such as for example bone, tissue, and organs, or other biological structures.

One or more (or all) of the voxels representing the scene may represent element(s) which are entirely virtual and not related to the ‘real world’ (corresponding to a virtual model, e.g. for a computer game, virtual reality application, or other application).

Additionally or alternatively, one or more (or all) of the voxels representing the scene may represent element(s) based on (corresponding to) the ‘real world’ (as may be the case in augmented reality, mixed reality, or other applications using ‘real world’ inputs for example as may be used for autonomous driving or robotic navigation).

In embodiments where the scene to be processed comprises one or more elements based on (constructed from) the ‘real world’, these may be constructed in any suitable and desired way. For example, data relating to the ‘real world’ may be (may have been) obtained by a sensor (in embodiments of the data processing system), for example comprising any of: a visual light detector (camera), infra-red detector, x-ray detector, microwave detector, audio detector (microphone), depth sensor, sonar, radar, LiDAR or other suitable and desired detector. For example, LIDAR may be used to generate a point cloud for the scene.

The data relating to the ‘real world’ may be (may have been) analysed (for example by a data processor of the data processing system) to identify elements of interest (to perform scene construction). For example, and in embodiments, identification of elements of interest (scene construction) may be performed using a machine learning process, for example performed by a neural engine (neural network processing unit, NPU) of the data processing system.

Elements of interest (identified from data relating to the ‘real world’) may (then) be represented as (converted into) one or more voxels (the identified elements may be voxelized), and incorporated into a hierarchical data structure representing voxels of the scene.

Since, in embodiments, a scene which is desired to be processed may change dynamically, identification of elements of interest (for example by an NPU of the data processing system), voxelization of elements of interest, and incorporation of data relating to voxels in the hierarchical data structure, may be performed in parallel with processing relating to the scene (as performed by an execution unit of a data processor of the data processing system executing suitable instructions).

It would be possible to represent the scene only using voxels, and in embodiments this is done. However, it would equally be possible to use a hybrid representation (and in embodiments this is done), for example the hybrid representation comprising a voxel based representation in combination with one or more other types of representation, and in embodiments this is done.

The processing to be performed (which is desired to be performed) for a scene represented by a set of one or more voxels in accordance with embodiments of the technology described herein could comprise any suitable and desired processing relating to the scene, providing a useful output.

For example, and in embodiments, it may be desired to perform (the data processing system may be operable to (configured to) perform) graphics processing (graphics processing operations) relating to the scene. The graphics processing may comprise, for example, rendering the scene to generate an image (frame), for example for display (on a display, for example a screen, of the data processing system). The graphics processing could additionally or alternatively comprise render-to-texture processing based on the scene. The graphics processing to be performed could be for any suitable and desired application, for example a video game, or extended reality (e.g. augmented reality, or virtual reality) application. The rendered image (frame) may be output, to a user, for example via a display of the data processing system.

Alternatively or additionally, it may be desired to perform (the data processing system may be operable to (configured to) perform) processing relating to the scene other than graphics processing (for example which does not consist of (or does not require any) graphics processing). Such processing may comprise (and in embodiments comprises) analysis of the scene, for example to analyse the positions and/or properties of element(s) represented by voxel(s) in the scene. This may be for the purpose of navigation (for example by an autonomous vehicle or other robotic device, for example using SLAM (simultaneous localisation and mapping)) or for medical, mechanical, geographical, computational fluid dynamic analysis, or other scene analysis. A result from the scene analysis may be output in any suitable way, for example being indicated to a user, for example via a display of the data processing system or other feedback such as for example haptic feedback.

In embodiments, the processing for the scene may be performed in real-time, with the processing being continually performed (updated) (for example as a view-point and direction from which the scene is viewed changes, and/or as the scene itself changes).

In accordance with the technology described herein, the processing relating to a scene represented by one or more voxels is performed by executing (program) instruction(s) on an execution unit of a (at least one) data processor of the data processing system.

In embodiments, a data processor (at least one of the data processors) comprising the execution unit on which instructions are performed (to which instructions are provided) for performing processing operations relating to the scene is a graphics processor (is configured as a graphics processor) (graphics processing unit, GPU) capable of performing (configured to perform) graphics processing (graphics processing operations), for example to render the scene to generate an image (frame) for display. The graphics processor may optionally be capable of performing (and used to perform) processing for the scene other than graphics processing. This may be appropriate, for example, where the processing desired to be performed for the scene comprises graphics processing, or other processing that may be efficiently performed on a graphics processor.

In this regard, the graphics processor may be configured with any of the usual processing elements, circuits, units and stages (e.g. graphics processing pipeline) that a graphics processor may contain for generating images (frames), for example for display, for example using rendering.

Alternatively or additionally a (at least one) data processor which is not a graphics processor may be used, with its execution unit(s) used for executing instructions to perform processing relating to the scene. This may be appropriate, for example, where the processing desired to be performed for the scene comprises processing other than graphics processing, which is more efficiently performed, on a processor other than a graphics processor.

For example, the data processor of (which is operated in the manner of) the technology described herein may be, a central processing unit (CPU), or a neural network processor (neural network processing unit, NPU) adapted for performing neural network processing (e.g. such as machine learning, ML). However, it would equally be possible to configure any suitable and desired processor in the manner of the technology described herein, for example such as a vector processor, a video processor (video processing unit, VPU), a sound processor, an image signal processor (ISP), a digital signal processor (DSP), an accelerator, or any other suitable and desired processor.

The data processor(s) used in the technology described herein may (each) have a single execution unit, or plural programmable execution units (one or more, or all, of which may be used for executing program instructions for performing processing relating to a scene represented by one or more voxels).

For example, a data processor may comprise one or more processing cores (also referred to herein as “shader cores” in the case of a graphics processor) each having a respective execution unit.

The (each) (programmable) execution unit, in embodiments, comprises appropriate circuits (processing circuits/logic) for performing operations required (that may be required) of the execution unit. Thus, the (each) execution unit, for example, and in embodiments, comprises a set of at least one functional unit (circuit) operable to perform data processing operations for an instruction being executed.

The functional unit or units can comprise any desired and suitable functional unit or units operable to perform data processing operations in response to and in accordance with program instructions. Thus the functional unit or units in an embodiment comprise one or more or all of: arithmetic units (arithmetic logic units) (add, subtract, multiply, divide, multiply-accumulate (MAC) etc.), bit manipulation units (invert, swap, shift, etc.), logic operation units (AND, OR, NAND, NOR, NOT, XOR, etc.), load-type units (such as varying, texturing or load units in the case of a graphics processor), store type units (such as blend or store units in the case of a graphics processor), etc.

The functional units can be implemented as desired and in any suitable manner, in embodiments as suitable hardware elements such as processing circuits (logic).

As noted above, in the technology described herein, to assist with handling voxel data for the scene to be processed (by the data processor(s) of the data processing system), the data processing system is provided with a traversal unit which is configured to traverse (walk) a hierarchical data structure representing the voxels of the scene, and access data relating to voxels from the leaf nodes of the data structure.

In this regard, as noted above, the Applicant has recognised that, since voxels represent volumes in space, data relevant to voxels can be efficiently accessed using a hierarchical data structure which spatially sorts the voxel data, and that a hardware accelerator (traversal unit) may provide an efficient way of doing this. In this regard, the hierarchical data structure may also be referred to herein as an “acceleration data structure”.

Example hierarchical data structures which may be used in the technology described herein to spatially sort voxels include a BVH tree (bounding volume hierarchy tree), a KD-tree, an Oct-tree, a grid hierarchy, a BSP tree (binary space partitioning tree).

From a general aspect, the hierarchical data structure used in the technology described herein to spatially sort voxel data comprises a plurality of nodes each associated with a respective volume within the scene, with one or more leaf nodes containing data relating to one or more voxels that occupy the volume associated with the respective leaf node.

In this regard, the hierarchical data structure may be configured as a tree structure, with nodes arranged hierarchically according to node volume size.

In embodiments each (non-leaf) node is a parent node for a respective set of child nodes, with the parent node volume encompassing the volumes of its respective child nodes in their entirety. Thus, in embodiments, each (non-leaf) node is associated with a respective plurality of child node volumes each representing a (in an embodiment non-overlapping) sub-volume within the overall volume represented by the node in question. Each (non-leaf) node could be associated with any desired number of child nodes, for example such as two, three, four, five, six, seven, eight or more child nodes. Each (non-leaf) node may have the same number of child nodes, or the number of child nodes could be permitted to differ among the (non-leaf) nodes. In embodiments each parent (non-leaf) node has a different set of child nodes, in embodiments so that no child node is shared between multiple parent (non-leaf) nodes.

The hierarchical data structure (tree structure) may originate at a (single) (root) node having a largest node volume, and branch through nodes having smaller volumes until a leaf node is reached. A leaf node is thus an end of a branch.

A (each) leaf node does not have any child nodes. Leaf nodes in an embodiment have non-overlapping volumes.

The volume associated a (each) leaf node (and likewise the volume associated with a (each) non-leaf (parent) node) may be any suitable and desired shape, in embodiments a cuboid (e.g. a cube).

In embodiments, the hierarchical data structure is a bounding volume hierarchy (BVH), in which the scene is subdivided on a per-element (or per-voxel) basis, by drawing suitable bounding volumes around elements (or voxel(s)), in an embodiment such that each leaf node (volume) corresponds to a certain number of elements of the scene (or voxel(s) representing elements of the scene).

Alternatively, the scene could be subdivided on a per-volume basis for the hierarchical data structure, so that leaf nodes correspond to substantially equally sized volumes. For example, the hierarchical data structure may comprise a KD tree structure, a grid hierarchy, etc., as desired. It would also be possible to use a ‘hybrid’ hierarchical data structure where the scene is subdivided in part on a per-element (per-voxel) basis and in part on a per-volume basis. Various other arrangements would be possible and the technology described herein may in general be used with any suitable hierarchical data structure.

In embodiments, one or more (or all) leaf nodes have a volume which contains respective one or more voxels in their entirety (so that a leaf node forms a bounding box for one or more voxels). This may occur, for example for leaf nodes which are axis-aligned and which contain one or more axis-aligned voxels (so that the leaf node, and its respective voxel(s) each correspond to a volume, e.g. cuboid, e.g. cube, with its axes oriented along x, y, and z axes that correspond to the axes of the three-dimensional scene to be processed, which may be the world axes).

In embodiments, the volume associated with a (and in embodiments each) leaf node is axis-aligned, and sized to fit one or more axis-aligned voxels in their entirety.

However, the Applicant has recognised that it may desirable to permit one or more voxels not to be axis-aligned (for example, corresponding to a volume, e.g. cuboid, e.g. cube, with its axes rotated relative to the x, y and z axes (world axes) of the three-dimensional scene to be processed). This may better describe elements in a scene which are not axis-aligned (for example are rotated). Thus, in embodiments, a (any) leaf node may comprise data relating to one or more voxels which are not axis-aligned. A non-axis-aligned voxel could fit entirely within a single leaf node (for example a sufficiently large axis-aligned leaf node, or a non-axis-aligned leaf node), or a non-axis-aligned voxel could span multiple leaf nodes.

The hierarchical data structure (for example having any of the features described above) may be constructed (built) in any suitable and desired way based on the scene to be processed as represented by one or more voxels.

As noted above, in the technology described herein one or more leaf nodes of the hierarchical data structure contain (are associated with) data relating to one or more voxels that occupy the volume associated with the respective leaf node.

Thus, in embodiments, when a voxel (one or more voxels) representing a (an element of a) scene falls within a volume represented by a leaf node of the hierarchical data structure, that leaf node is provided with (is configured to contain) data relating to that voxel (those voxels).

It would be possible to have (permit) (only) a single type of leaf node, comprising (only) a single type of information, for example comprising voxel data (or pointing to voxel data in storage), the voxel data describing (for example indicating properties of) a (each) voxel represented by the leaf node, and in embodiments this is done.

However, the Applicant has recognised that it may be advantageous to permit (support) plural types of leaf node, each comprising a different type of information relating to one or more voxels representing a scene.

Thus, in embodiments, the hierarchical data structure is configured to allow plural (different) types of leaf node (comprising different types of information).

Thus, in embodiments, the hierarchical data structure is configured to allow one or more leaf nodes of a type comprising voxel data, and one or more leaf nodes of another type (not comprising data other than voxel data).

For example, and in embodiments (as will be discussed in more detail below), types of information which a leaf node may comprise include any of: voxel data or a pointer to a region of storage storing voxel data (the voxel data describing properties of voxel(s)); hash data (indicating that a hash function is to be used to access voxel data from storage); an indication that one or more additional data structures are to be traversed to obtain voxel data; an indication that a (shader) program is to be executed.

The type of leaf node (type of information stored in a leaf node) may be apparent (derivable) from the data (information) (relating to one or more voxels representing a scene) stored within the leaf node. Alternatively, the type of leaf node (type of information stored in a leaf node) may be indicated in any suitable and desired way. For example, a (each) leaf node may be associated with (for example store, for example in a suitable data field or as metadata) an indication of its type.

In embodiments, a (any) leaf node is permitted to change type (the type of information stored in a leaf node is permitted to change, for example between any of the types disclosed herein).

In embodiments (as noted above), the data relating to one or more voxels which a leaf node comprises may be voxel data or a pointer to a region of storage storing voxel data, the voxel data describing voxel(s) themselves, for example describing properties of a (each) voxel occupying the volume associated with the leaf node.

Thus, one or more (or all) leaf nodes of the hierarchical data structure may comprise data relating to one or more voxels comprising voxel data or a pointer to a region of storage storing voxel data.

The voxel data may be any suitable and desired information that may be required for performing processing (e.g. rendering, or other processing) of the voxel(s), for example comprising (visual properties comprising) any of: voxel coordinates (for example, x,y,z coordinates for one or more (or each) corner of the voxel), voxel colour (for example RGB colour), voxel size, voxel transparency (alpha), voxel texture (for example indicating a material, reflectivity, plenoptic function or other texture which the voxel represents). The voxel data could also contain an indication of whether the voxel is axis-aligned or not (for example a rotation about one, two, or three axes). The voxel data may also comprise one or more other (non-visual) properties of the voxel(s), for example movement vector(s) (indicating for example a direction and speed of movement of the voxel), or other (non-visual) properties.

In embodiments, the voxel data which is provided in (or pointed to by) a leaf node comprises (at least) data to allow the traversal unit to determine whether the voxel is of interest (for example is intersected, for example based on an origin and direction of interest used for traversing the hierarchal data structure, for example as described in more detail below). Thus, in embodiments voxel data comprises (at least) information regarding the size and/or position of the voxel, for example comprising one or more of: voxel co-ordinates, voxel size, and whether the voxel is axis-aligned or not.

As noted above, voxels may vary in size. Thus, the voxel data indicated (pointed to) in a leaf node may correspond to a voxel of any suitable and desired size.

The voxel data (when stored or pointed to in a leaf node) is in embodiments configured to occupy one or more cache lines of storage (in their entirety). For example, where a cache line is 32, 64, or 128 bytes, a (each) leaf node stores or points to storage comprising voxel data of a corresponding size (of 32, 64, or 128 bytes). This may allow efficient data storage of voxel data, and efficient data access when processing of the scene is to be performed since cache lines can be accessed and used in their entirety.

In embodiments (instead of a leaf node comprising voxel data), a leaf node may indicate a further data structure is to be used (walked) (traversed) to identify (determined) voxel properties.

The further data structure may be referred to herein as a “bottom level acceleration structure” (BLAS)). The further data structure (BLAS) may comprise a hierarchical data structure (for example having any of the features discussed herein with respect to hierarchical data structures), for example a tree. The further data structure (BLAS) may provide (spatially sort) information relating to voxel(s) (of an element (instance)) in model space.

(In comparison, the acceleration data structure ending in the leaf node in question can be considered a “top level acceleration structure” (TLAS), which may spatially sort the world space of the scene to be processed.)

In embodiments, when a leaf node indicates that a further data structure (BLAS) is to be used, there may be multiple further data structures (BLAS) available to be used, each further data structure (BLAS) providing voxel properties (for voxel(s) representing an element (instance) occupying the leaf node volume) at a different level of detail.

In the case that multiple further data structures (BLAS) are available, the leaf node could itself indicate which further data structure (BLAS) is to be used. Alternatively, the data processing system (for example the traversal unit) could select a further data structure (BLAS) to use (for example according to a level of detail at which voxel(s) are desired to be processed).

In the case that a further data structure (BLAS) is a hierarchical data structure, one or more leaf nodes of the further data structure may contain (or point to storage containing) voxel data (the voxel data describing properties of the voxel(s), for example any of the voxel properties described herein). In this case, data relating to the voxel(s) may be obtained by (the traversal unit) walking (traversing) the (appropriate) further (hierarchical) data structure (BLAS), until a leaf node of the further (hierarchical) data structure is reached.

In embodiments, data relating to one or more voxels which is stored in a (one or more) leaf node(s) (of a hierarchical data structure traversed by the transversal unit in response to the execution unit executing an instruction indicating that a traversal is to be performed) may comprise hash data.

The hash data provided by (stored in) a leaf node in embodiments comprises an indication that a hash function is to be used to access voxel data (such as the voxel data, comprising voxel properties, described above) from storage.

In this regard, using a hash function may provide a particularly fast way of accessing voxel data from storage.

The hash data provided by (stored in) a leaf node may (and in embodiments does) indicate storage (for example a buffer) assigned (provided) for storing voxel data (for one or more (any) voxels falling within the volume associated with the leaf node), and from which voxel data is to be accessed using a hash function.

The hash function to be used may be known to the data processing system (for example, the hash function being the same for all leaf nodes storing hash data).

However, in an embodiment a leaf node can (does) indicate the hash function to be used. This allows different leaf nodes to indicate different hash functions.

The hash function when evaluated (solved) (for an input (hash key)), provides an output (hash value) indicative of a region of (entry in) storage (representing a region of the scene to be processed) (for example the storage indicated in the leaf node), from which voxel data is to be accessed (of a plurality of regions of (entries in) storage which can store (are provided for storing) voxel data).

The leaf node could provide an indication of the input to be used for the hash function (the hash key), and in embodiments this is done. For example, co-ordinates (for example x, y, z co-ordinates) associated with the leaf node in question may be used (at least in part) as the input to the hash function.

Alternatively or additionally, the data processing system (traversal unit) may determine an input to the hash function (hash key) based on the traversal performed (for example based on the origin and direction for the traversal, for example from which co-ordinates of interest may be determined and used as an input to the hash function).

The output (hash value) may be, for example, a pointer to a region of storage (for example, of the storage indicated in the leaf node). For example, the output (hash value) could be an offset value, relative to a base address of the storage (the base address being provided in the leaf node).

The output (hash value) could alternatively be an index which maps to a region of storage (for example, of the storage indicated in the leaf node), of a plurality of possible indices each mapping to a respective, different, regions of (the) storage, for example according to a hash table that maps indices to respective regions of storage. The mapping (hash table) may be known to the data processing system, for example stored in suitable storage. The output (hash value) from the hash function could be an index for (to be in input into) a first hash table, of a hierarchy of plural hash tables to be walked (traversed) to identify a region of storage from which voxel data is to be accessed. In this case, a (same or different) hash function (for example indicated in the leaf node) may be used to derive an index for (to be input into) each hash table as the hierarchy is walked (traversed). Using a hierarchy of hash tables may be appropriate, for example to efficiently access voxel data from storage storing (capable of storing) a large number of voxels.

Each successive hash table in the hierarchy of hash tables to be walked may have entries representing (may map indices to) different, for example progressively smaller, regions of storage (for example representing progressively smaller regions of space of a scene). In embodiments, each hash table in the hierarchy of hash tables may correspond to (map indices to regions of storage storing the scene at) a different level of detail (with successive (lower) tables relating to greater levels of detail).

In this regard, as discussed above, voxels in different regions of a scene may be desired to be processed (e.g. rendered) at different levels of detail, for example depending on closeness of a voxel to a user's viewpoint and/or the complexity of an element (e.g. object) represented by the voxels. For example, voxel(s) that are closer to a user's viewpoint and/or correspond to a relatively more complex element (object) of the scene may be processed at a greater level of detail (be smaller than) voxel(s) which are further away from a user's viewpoint.

By providing a hierarchy of hash tables, the hierarchy of hash tables can be walked to a hash table corresponding to an appropriate level of detail for the voxel(s) (region of the scene) represented by a leaf node in question. This may be achieved in any suitable and desired way. For example, a leaf node could indicate which table (level) in the hierarchy of hash tables should be used for accessing voxel data from storage. Alternatively, the hash table(s) could, themselves be configured so that (for a particular region in space of a scene to be processed which a leaf node corresponds to) a walk (traversal) ends at a particular hash table in the hierarchy.

From a more general aspect, in embodiments, when a leaf node comprises hash data, a plurality of possible hash tables (and respective possible hash functions for determining an index to be mapped using the hash tables) may be available for use when determining a region of storage to access voxel data from. In embodiments, the plurality of possible hash tables for use represent (point to) regions of memory which (compared to other hash table(s)) represent differently sized regions of space in a scene to be processed (such that different hash tables may represent a scene at different levels of detail).

A (one or more (a plurality of), for example a hierarchy of) hash tables (and associated hash functions) to be used may be indicated in a leaf node itself, or could be otherwise determined (known) by the data storage system, for example depending on the level of detail at which the region (volume) of the scene (voxel(s)) represented by the leaf node are desired to be processed.

In embodiments (as noted above), the data relating to one or more voxels which is stored in a leaf node may (is permitted to) comprise an indication of a program to be executed for processing the voxel(s) occupying the volume associated with the leaf node. In other words, one or more (or all) leaf nodes of the hierarchical data structure may contain an indication of a program (shader program) to be executed.

The Applicant has recognised in this regard, that it is possible to (and indeed may be useful to) explicitly indicate a program for processing voxel(s) that fall within a leaf node volume. In this way, the processing to be performed by the data processor for voxel(s) can be specified by the leaf node, and tailored (configured) for the leaf node (voxel(s)) in question. This may permit (and in embodiments specify) processing which differs from the usual (default) processing performed by the data processor (to allow for processing which is non-standard).

In comparison, for a leaf node only providing voxel properties, for example obtained via information concerning voxel data, hash data, or a further hierarchical data structure as discussed above, the data processor for example may (and in embodiments does) determine the processing to be performed based on the voxel properties (and not based on any indication in the leaf node of a program to be executed)

In embodiments where the data processor which is to process the voxel(s) falling within a leaf node volume is a graphics processor (GPU), then a program indicated by the leaf node may be a shader program for processing voxel(s) falling within the leaf node volume, in embodiments so as to render the voxel(s), for example for display.

For example, the program may comprise a (shader) program which (when executed) renders a region of the scene (corresponding to the leaf node volume, for example rendering voxel(s) falling within the leaf node volume) to provide a particular (prescribed) visual effect, for example using a particular (prescribed) visual filter (for example a colour filter), texture, luminosity, transparency or opacity, animation, or other visual effect.

For example, in the context of the context of medical imaging, the program indicated in the leaf node may be a (shader) program that (when executed) highlights a region (voxel(s)) corresponding to a tumour, by rendering a glow effect around that region. As another example, a voxel representation of a LiDAR scan of a building may comprise a region with structural damage, in which case a leaf node having a volume (voxel(s)) corresponding to the damaged region may be provided with a (shader) program which (when executed) renders the areas with structural damage with a particular visual property (for example a red colour, with a danger symbol in the texture).

It would additionally or alternatively be possible for a leaf node to indicate a program for processing voxel(s) falling within a leaf node which does not involve (require) graphics processing. For example, the indicated program could relate to (and when executed cause) processing for scene analysis. In this case, the program could be executed by any suitable and desired processor of the data processing system, for example a graphics processor, central processing unit (CPU) or other processor.

For example, the program may comprise a program which (when executed) causes the data processing system to provide an output to a user of the data processing system other than a rendered output (image), for example an audio output, a haptic output, a visual output (for example illuminating a light). For example, the program may (when executed) generate a sound effect (for example a warning sound or recorded voice description) or provide haptic feedback, for example when the user (camera) approaches a region of the scene containing voxel(s) and represented by the leaf node.

Alternatively or additionally, the program (when executed) may cause the data processing system to perform analysis (of the scene) which does not directly generate an output for a user of the data processing system. For example, the program (when executed) may cause a data processor to analyse a region of the scene containing voxel(s) and represented by the leaf node. For example, in the context of robotic navigation, the data processor may determine whether a hazard is encountered or not. As another example, in the context of a scene relating to a building, the program (when executed) may cause a data processor to analyse a region of the scene (building) corresponding to the leaf node (and represented by voxel(s)) for example to determine whether there is a structural defect, or for example to perform other structural calculations.

As noted above, the processing to be performed for a scene represented by one or more voxels may be performed by the data processing system in real-time (for example, for a video game application, extended reality application or real-time scene analysis), and so the program to be executed (and which is indicated in a leaf node) is in embodiments adapted (configured) to permit real-time processing of the voxel(s) falling within a leaf node volume. In embodiments, the program to be executed is configured based on the hardware processing capabilities of the data processor (e.g. graphics processor) which is to perform the processing, so as to allow ‘real-time’ processing.

The indication of a program to be executed for processing voxel(s) could be provided in the leaf node in any suitable and desired way. For example, and in embodiments, a leaf node may comprise a pointer to storage of the data processing system which stores a program (program instructions) (for example, in local on-chip storage, or in off-chip storage (main memory)). Alternatively, a leaf node could comprise an identifier (ID) for a program to be executed, which can then be used to determine (look up) the program to be executed.

In embodiments, in addition to an indication of a program to be executed, a leaf node also comprises data (a payload) to be processed using the program.

The data (payload) may comprise any suitable and desired information for use when executing the program for voxel(s) falling within the leaf node volume.

For example, the data (payload) may comprise voxel data (for example as described above, describing one or more properties of voxel(s)) falling within the leaf node volume.

Thus, in embodiments, the payload may comprise voxel data describing one or more properties of the voxel(s), for example any of the voxel properties described herein, such as one or more of: voxel coordinates, voxel colour, voxel size, voxel transparency (alpha), voxel texture, an indication of whether the voxel is axis-aligned or not, movement vector(s), or other voxel properties.

Similarly to the above discussion in respect of leaf nodes storing voxel data), the voxel data may comprise (at least) data to allow the traversal unit to determine whether the voxel is of interest and should be processed according to the indicated program (for example to determine whether a voxel is intersected, for example based on an origin and direction of interest used for traversing the hierarchal data structure, for example as described in more detail below). Thus, in embodiments the voxel data may comprise (at least) information regarding the size and/or position of the voxel.

The data (payload) may alternatively or additionally comprise to data to be used when processing (rendering or otherwise analysing) the region of the scene corresponding to (voxel(s) falling within) the leaf node.

For example, in the context of a scene representing a building, and a program indicated in the leaf node for performing structural analysis (structural calculations) of an element (object) represented by the voxel(s), the data (payload) may comprise properties about the material of (or possible materials for) the element (object), for example the type of material (for example type of concrete, type of rebar etc.).

As another example, in the context of a program for providing an animation, the payload may comprise animation data for use when executing the animation.

The data relating to one or more voxels that a leaf node comprises, may be (and in embodiment is) compressed, so as to facilitate storage of leaf node data in storage (e.g. local on-chip storage, or off-chip main memory) of the data processing system. Equally, voxel data in storage may be compressed.

As noted above, in the technology described herein, traversal of a hierarchical data structure representing voxels of a scene, is performed by a traversal unit (a hardware accelerator). The traversal unit is caused to traverse (walk) the hierarchical data structure in response to an execution unit executing an instruction indicating that a traversal is to be performed (which may be referred to herein as a “voxel traversal instruction”).

In embodiments, the traversal unit (circuit) is a hardware unit (for example a substantially fixed function hardware unit (circuit)). The traversal unit (circuit) may comprise appropriate fixed function circuits to perform the operations described herein, although it may comprise and have some limited form of configurability, in use, e.g. if desired.

The traversal unit (circuit) (hardware) of the technology described herein may be configured within the data processing system in any suitable and desired way (provided that its operation can be triggered by an execution unit of a data processor of the data processing system in response to an execution unit of a data processor executing a “voxel traversal instruction”, in other words provided that the execution unit is in communication (able to communication with) with the traversal unit).

For example, the traversal unit could be configured as part of (e.g. within a same chip as) a data processor (for example a CPU or graphics processor or other data processor) which is performing (is to perform) processing of a scene represented by one or more voxels (whose execution unit executes the “voxel traversal instruction” which triggers a traversal).

For example, the traversal unit may be provided as part of a processing (shader) core of the data processor. In embodiments, each processing core comprises, or a sub-set of processing cores comprise, a respective traversal unit, in embodiments such that there are plural traversal units. Alternatively, a traversal unit provided on a (single) processing core could be shared among plural processing cores, for example being provided on a (single) processing core but triggerable (usable for processing performed on) another (any other) processing core.

Thus, there may be a single or plural traversal units. For example plural execution units may share a given (or a single) traversal unit. Alternatively, a given execution unit may have access to and communicate with and use plural different traversal units (circuits). Where there are plural traversal units (circuits), each such unit can in an embodiment operate in the manner of the technology described herein.

As will be discussed in more detail below, in embodiments where the data processor (which is to perform processing of the scene) is a graphics processor, the traversal unit may, at least in part, share circuit(s) with a ray tracing unit (RTU) the graphics processor. However, it would equally be possible for the traversal unit not to share (any) circuit(s) with a (any) ray tracing unit (RTU) of a graphics processor.

Regardless of the exact location of the traversal unit in the data processing system, the traversal unit (circuit) will in an embodiment have a messaging interface for communicating with an execution unit of a data processor as required. Thus, in embodiments, a communication (messaging) network is provided for passing messages between the traversal unit (circuit) and the execution unit (from the execution unit to the traversal unit, and vice versa). The communication (messaging) network may operate according to any desired communications protocol and standard, such as using a suitable interconnect/messaging protocol.

In embodiments, an (any) execution unit of a data processor (for example a CPU or graphics processor or other data processor), in response to executing an instruction indicating that a traversal is to be performed (a “voxel traversal instruction”), indicates to the traversal unit that a traversal should be performed, for example by sending a message to the traversal unit that a traversal should be performed. In response to receiving a message from an execution unit indicating that a traversal should be performed, the traversal unit traverses the hierarchical data structure to access data relating to voxel(s).

The traversal unit may be configured to traverse (walk) the hierarchical data structure in any suitable and desired way to access data relating to voxel(s), for example falling within a region of interest in the scene.

In embodiments, the traversal unit is configured to traverse (walk) the hierarchical data structure based on an origin (a position, for example in the scene, for example from which the scene is (or is to be) viewed, which may be defined as x, y, z coordinates) and/or a direction (direction vector) (for example corresponding to a direction in which the scene is (or is to be) viewed), to arrive at a leaf node representing a volume of interest in the scene (for which any voxel(s) therein are to be processed). The traversal could also be performed based on a range (distance) into the scene to be considered (for example, a distance from a viewer or camera).

In this regard, an origin and direction of ‘viewing’ the scene (a view direction), in the context of an extended reality application (e.g. AR application) requiring processing of the scene could be based on a position and orientation of a user (as determined, for example by head tracking). For other program applications, for example performing scene analysis (such as discussed above, e.g. for autonomous driving), the origin and direction of ‘viewing’ the scene need not correspond to an actual human user of the scene, but rather a direction of ‘viewing’ for the purposes of the scene analysis.

It would be possible to determine the origin and direction (and optionally range) to be used for the traversal in any suitable and desired way.

In embodiments, the execution unit, when causing the traversal unit to perform the traversal, indicates to the traversal unit the origin and direction (and optionally range (distance) into the scene) to be used. In embodiments the origin and direction (and optionally range) to be used are provided (indicated) in the instruction (“voxel traversal instruction”) executed by the execution unit, and are communicated from the execution unit to the traversal unit when causing (e.g. sending a message) that a traversal should be performed.

Alternatively, the origin and direction (and optionally range) could be determined by the execution unit and/or the traversal unit without being explicitly indicated in the instruction (“voxel traversal instruction”). For example, an origin and direction (e.g. of viewing) could be stored in storage accessible to the execution unit and/or traversal unit (and used for performing the traversal).

In embodiments, the traversal unit is configured to traverse (walk) the hierarchical data structure, starting at one or more nodes corresponding to a largest volume in the hierarchy (one or more “root” nodes), and based on the origin and/or direction (of viewing) to follow one or more branches (through any child node(s)) until a leaf node is reached (or, where the walk is limited by a range into the scene, until that range is reached, if sooner).

This may comprise, for a (non-leaf) node associated with a set of plural child nodes, determining which child node(s) are of interest, comprising determining (testing) which child node volume(s) are intersected (based on the origin and/or direction for the traversal). The node(s) which are determined to be intersected may then have their child nodes tested for an intersection, and so on until a leaf node is reached (the leaf node having no child nodes) (or until the range into the scene is reached, if sooner).

The traversal unit (circuit) in embodiments comprises a (dedicated) walk engine (a walk unit (circuit)) configured (in particular) for performing the walk of the hierarchical data structure. The walk circuit may comprise any suitable and desired hardware configuration (specifically) adapted for performing the walk of the hierarchical data structure (for example, for determining at each (non-leaf) node, which branch should be traversed (which child node volume(s) are intersected), until a leaf node is arrived at).

The node volume(s) to be tested for volume intersection may be obtained in any suitable fashion. For instance, the node volumes may be stored in storage (for example of or accessible to the data processor, for example a main off-chip memory of the data processing system, for example accessible via a cache hierarchy), and loaded from storage as required for volume intersection testing of a given node. In embodiments, node volume(s) to be tested are loaded into a local on-chip storage accessible to the traversal unit, in embodiments into a cache (“walk cache”) of the traversal unit.

Thus, in embodiments, the traversal unit (circuit) comprises a cache (walk cache) for (at least temporarily) storing data relating to the traversal, such as one or more node volumes (loaded from main memory) to be tested for intersection.

The Applicant has recognised that the traversal (walk) of the hierarchical data structure, as described herein, may have similarities to the traversal of a ray tracing acceleration data structure performed for ray tracing in a graphics processor.

In this regard, the present traversal may be performed, in effect, by casting one or more ‘rays’ with an origin and direction through the hierarchical data structure, and following a path through the hierarchical data structure accordingly, until a leaf node is reached. This may comprise, testing the ‘ray’ for intersection with one or more (child node) volumes associated with a node of the hierarchical data structure to determine which of the associated volumes (child nodes) is intersected by the ray, then subsequently testing the ray for intersection with the volumes associated with the (child) node in the next level of the hierarchical data structure, and so on, down to the lowest level (leaf) nodes.

Thus, in embodiments where the traversal unit (circuit) of the technology described herein is configured as part of a graphics processor, the traversal unit may share at least some circuitry (circuits) with a ray tracing unit (RTU) (circuit) of a graphics processor. For example, and in embodiments, either or both of the walk unit (circuit) and the walk cache may be shared with (be part of) a ray tracing unit.

In this regard, the Applicant has recognised that the technology described herein may be implemented, at least in part, using an (existing) ray tracing unit of a graphics processor to perform some or all of the operation of the traversal unit (e.g. to assist with traversing a hierarchical data structure). This may help to reduce the overall area required to implement the “voxel” traversal unit.

However, it is noted that a conventional ray tracing unit of a graphics processor, whilst capable of traversing a ray tracing acceleration data structure, typically is not configured for handling leaf nodes containing voxel data as are present in the hierarchical data structure of the technology described herein. Thus, whilst the traversal unit of the technology described herein may share at least some circuitry (circuits) with an existing ray tracing unit (for the purposes of performing the traversal (walk)), it should, and in an embodiment does, have additional functionality and interacts with the data processing system in a different manner, as described herein.

Alternatively, the traversal unit of the technology described herein could be, and in embodiments is, provided separately to (and does not share circuits with) a (any) ray tracing unit.

As noted above, when performing a traversal, the traversal unit walks (traverses) the hierarchical data structure, until a leaf node is encountered. When a leaf node is encountered that contains data relating to one or more voxels, the traversal unit then triggers processing relating to the one or more voxels.

As noted above, in embodiments, the hierarchical data structure is permitted to contain plural different types of leaf node. In such embodiments, the traversal unit is in an embodiment configured to support (handle) multiple leaf node types (and to trigger or perform appropriate processing according to (based on) leaf node type).

The traversal unit may be, and in embodiments is, configured to determine the ‘type’ of leaf node is based on an (explicit) indication of leaf node type provided for the leaf node (e.g. in a ‘type’ field, as discussed above).

Alternatively or additionally, the traversal unit may be, and in embodiments is configured to determine the ‘type’ of leaf node is based on the leaf node data (relating to one or more voxels represented by the leaf node). For example, the traversal unit may be configured to recognise (infer) a leaf node type based on the data provided in the leaf node relating to one or more voxels, for example by recognising one or more (or any of) an indication of a further data structure to be traversed, hash data, and an indication of a (shader) program to be performed (and the traversal unit configured to trigger or perform appropriate processing based on the recognised leaf node type).

In embodiments, the traversal unit is configured, when a leaf node is of a type (is determined by the traversal unit to be of a type) comprising voxel data (or a pointer to a region of storage storing voxel data) describing properties of one or more voxels falling within the volume of the leaf node, to test (to perform processing relating to one or more voxels comprising testing) whether a (any) voxel falling within the volume of the leaf node is of interest and should be processed.

In embodiments, determining whether a (any) voxel should be processed comprises determining whether the leaf node (actually) contains any voxel data.

In this regard, it is possible for a leaf node (of the type which is to contain voxel data) to contain no voxel data (be empty) if no voxel falls within the volume associated with the leaf node.

In embodiments, the traversal unit is configured to, in response to determining that a leaf node (of the type which is to contain voxel data) contains no data (is empty), to inform the data processor that no voxel is to be processed (that there was no voxel intersect) (for example, by sending a message to the execution unit of the data processor that triggered the traversal).

When a leaf node does (is determined by the traversal unit to) contain voxel data for one or more voxels, the traversal unit may (then) determine whether any of the voxel(s) are of interest (are intersected) and should be processed.

This may comprise determining (testing) whether a voxel is (any of the voxels are) is to be viewed (are intersected, based on the origin and direction of the traversal). In this regard, whilst a voxel may fall within a leaf node volume, it may not actually be within the desired view (may not actually be intersected).

In embodiments, determining whether a voxel is intersected comprises comparing the volume occupied by (of) the voxel against a position of interest within the leaf node volume (as determined based on the origin and direction used for the traversal). The volume occupied by the voxel may be determined based on one or more (or all) of coordinates of the voxel and/or based on the size of the voxel (as may be indicated in the voxel data). In embodiments, determining whether an intersect occurs also comprises accounting for whether or not the voxel is axis aligned.

In embodiments, the traversal unit is configured to take account of voxel transparency (for example as indicated in the voxel data) when determining whether any voxel(s) are of interest (are intersected) and should be processed. For example, if a voxel which is intersected is (at least partially) transparent, the traversal unit may then determine whether any other voxel(s) (for example lying behind the transparent voxel) are intersected.

The traversal unit may have a (dedicated) intersect unit (circuit) configured (in particular) to determine whether a voxel (for which voxel data is provided in a leaf node) is intersected. The traversal unit may also comprise storage (a “leaf cache”) into which voxel data obtained from leaf node(s) is loaded, for use when testing for a voxel intersect.

Thus, in embodiments, the traversal unit is configured to, when a leaf node containing voxel data (or pointing to storage containing voxel data) is encountered, load the voxel data into storage (the “leaf cache”) of the traversal unit, for use when testing for a voxel intersect.

In embodiments, when it is determined that a voxel is of interest and should be processed (when it is determined by the intersect unit of the traversal unit that a voxel is intersected), the traversal unit triggers appropriate processing (e.g. rendering, or other analysis) of the voxel by the data processor. This may be done in any suitable and desired way, for example by informing a data processor of the voxel(s) which should be processed (for example sending a message to the to the execution unit of the data processor which triggered the traversal). This may comprise informing the data processor that (sending a message to the execution unit indicating that) a voxel intersect has occurred, and in an embodiment indicating which voxels have been intersected. The traversal unit may provide the data processor with (the message may comprise) any suitable and desired information to assist with the processing to be performed by the data processor, for example comprising any (or all) of the voxel data from the leaf node.

In embodiments, when no voxel is intersected, the traversal unit may indicate to the data processor (the execution unit thereof) that no voxel is intersected (and no voxel is to be processed).

In embodiments, the traversal unit is configured to, when a leaf node is of a type (is determined by the traversal unit to be of a type) requiring a further data structure (BLAS) to be traversed, traverse (perform processing relating to one or more voxels comprising traversing) the further data structure to obtain voxel data (to obtain voxel properties, for voxel(s) occupying the leaf node volume). If the further data structure (BLAS) has multiple different paths that can be traversed (walked), the traversal unit (walk unit) determines which path to traverse (walk).

The traversal of the further data structure (BLAS) may be performed similarly to the (initial) hierarchical data structure (TLAS), as discussed above. For example, and in embodiments, the traversal unit traverses the further data structure (BLAS) based on an origin and/or direction for the traversal (which, if the further data structure relates to a model space for an element of the scene, may be an origin and/or direction in model space, transformed from the origin and/or direction of viewing the scene).

The traversal of the further data structure (BLAS) is in embodiments performed by the dedicated walk unit of the traversal unit.

The traversal unit (walk unit) in embodiments traverses the further data structure until a leaf node is encountered. The leaf node(s) of the further data structure contain voxel data (or point to a storage location storing voxel data) (similarly to the discussion above with regards to leaf nodes of the (initial) hierarchical data structure (TLAS)).

In embodiments, the traversal unit handles leaf node(s) of the further data structure which are encountered and which contain (or point to a storage location storing) voxel data, in a similar way as leaf nodes of the (initial) hierarchical data structure (TLAS) which contain (or point to a storage location storing) voxel data (as discussed above). That is, the traversal unit may determine whether any voxel(s) for which voxel data is provided are of interest and should be processed, and inform the data processor of the same (by sending a message to the execution unit thereof to trigger processing of those voxels). This may comprise (as discussed above), determining whether any voxel data is actually present for the leaf node (or whether the leaf node is empty), and then determining (by the intersect unit) whether the voxel(s) for which voxel data is present are intersected (based on the origin and/or direction of the traversal), and informing the data processor (by sending a message to the execution unit thereof) of the voxel(s) which are intersected and should be processed.

As discussed above, in embodiments multiple different further data structures may be available for use to obtain voxel data (properties) for voxel(s) (representing an element (instance)) occupying the leaf node volume, for example different further data structures providing voxel data at a different levels of detail. In embodiments, the traversal unit is configured to determine which further data structure (of the multiple available further data structures) to use (traverse).

In embodiments, the traversal unit may determine (may be configured to determine) which further data structure to traverse based on an indication in the leaf node indicating which further data structure is to be traversed.

Alternatively, or additionally, in embodiments (when the leaf node does not indicate which further data structure to traverse), the traversal unit may determine (may be configured to determine) which further data structure to traverse based on a desired level at which (the voxel(s) of) the region of the scene to which the leaf node corresponds is to be processed. For example, the traversal unit may determine, for a leaf node corresponding to a volume of the scene which is close to the origin of view (close to a viewer) that a further data structure representing voxel(s) at a higher level of detail should be used (traversed), whereas for a leaf node corresponding to a volume of the scene which is further from the origin of view (further from a viewer) a further data structure representing voxel(s) at a lower level of detail should be used (traversed). This determination could be performed on a hardware level (that is, the traversal unit hardware could perform the determination).

Alternatively, the instruction that triggered the traversal (the “voxel traversal instruction”) could contain information regarding the level of detail at which voxel data is required (and so provide information concerning which further data structure is to be traversed, in the case that a leaf node requiring traversal of a further data structure is encountered). This information may be provided to the traversal unit (by the execution unit in response to executing the instruction), and the traversal may use this information to determine which further data structure to use.

Alternatively, (when the leaf node and/or the traversal instruction do not indicate which of plural possible further data structures to traverse), the traversal unit could delegate the determination of which further data structure is to be used, to another component of the data processing system, for example to the data processor which is to perform processing for the scene (with the answer being returned to the traversal unit to cause (permit) the appropriate traversal). In this case, the determination may be performed by running suitable software (for example a shader program). Thus, in embodiments, the traversal unit may be configured to (when the leaf node and/or the traversal instruction do not indicate which of plural possible further data structures to traverse), trigger the data processor to execute (on an execution unit thereof) a (shader) program to determine which further data structure to use.

In embodiments, the traversal unit is configured to, when a leaf node is of a type (is determined by the traversal unit to be of a type) comprising hash data, cause (perform processing relating to one or more voxels comprising causing) a hash function (one or more hash functions) to be used to access voxel data from storage.

In this regard, the traversal unit may be configured itself to evaluate (solve) one or more hash functions to determine a region of storage from which to access voxel data. In such embodiments, the traversal unit may comprise a hash unit (circuit) configured (particularly) for this purpose. The Applicant has recognised in this regard that providing hardware capability within the traversal unit for evaluating leaves of the type containing hash data can allow efficient evaluation of the hash function(s), which may outweigh the additional hardware area cost.

Thus, in embodiments, the traversal unit (hash unit) is configured to evaluate (solve) a hash function (one or more hash functions) based on an input (one or more inputs) (hash key(s)), to determine an output (hash value) indicative of a region of storage from which voxel data (indicating voxel properties) is to be accessed. (As discussed above with regards to leaf nodes comprising hash data), the output indicative of a region of storage may be a pointer to a region of storage, or an index which maps to a region of storage (for example according to a hash table).

It may be the case that a single hash function (and hash table) is (needs to be) used (evaluated) for a leaf node to arrive at an indication of a region of storage from which voxel data is to be accessed.

However (as discussed above), it may be the case that plural (a hierarchy of) hash functions need to be used (evaluated) (and a corresponding plurality of hash tables need to be used (walked)) for a leaf node to arrive at an indication of a region of storage from which voxel data is to be accessed. Thus, the traversal unit (hash unit) is in embodiments able to (configured to) evaluate a plurality of hash functions (walk a hierarchy of hash tables) to identify a region of storage from which voxel data is to be accessed.

In response to (the hash unit) solving the hash function, the traversal unit may load voxel data (indicating voxel properties) from the identified region of storage, for example into its “leaf cache”, determine whether the voxel(s) for which voxel data has been accessed are of interest (are intersected) and should be processed, and if so trigger processing of those voxels which are determined to be of interest by the data processor (in the same manner described above with respect to voxel data obtained (directly) from leaf nodes of the type containing or pointing to voxel data).

Alternatively, it would be possible for the traversal unit to delegate the evaluation of the hash function(s) (to determine the region of storage from which voxel data is to be obtained) to another component of the data processing system (for example the data processor which is to process the scene), and in embodiments this is done. Thus, in embodiments, the traversal unit is configured to, in response to encountering a leaf node (of a type) comprising hash data, inform the data processor (for example by sending a message to the execution unit) that the leaf node comprises (is of a type comprising) hash data (and for example send any hash data from the leaf node to the data processor). In response, the data processor (execution unit) in embodiments then executes a software program to identify using one or more hash functions the region of storage from which to access voxel data.

In embodiments where evaluation of the hash functions(s) is delegated to the data processor, it would be possible for the data processor (execution unit) to obtain voxel data from the indicated region of storage and (directly) use that voxel data for performing processing for the scene. However, in embodiments the traversal unit is (still) used to determine whether the voxel(s) for which data is obtained are of interest (are intersected) prior to the data processor using the voxel data for performing processing of the scene. In such embodiments, the data processor (execution unit) returns to the traversal unit an indication of the region of storage from which voxel data is to be obtained, or the voxel data as obtained from storage, so that the traversal unit can determine whether those voxel(s) are of interest (are intersected).

With regards to the particular hash function(s) and/or hash table(s) used for a leaf node, these could be (and in embodiments are) indicated in the leaf node itself.

However, it would instead be possible for the hash function and/or hash table not to be indicated in the leaf node. In this case, the traversal unit (hash unit) (or data processor) may be configured to use a known, e.g. predetermined, hash function and/or hash table (for example a same hash function and/or hash table used for all leaf nodes requiring hash data), or to otherwise determine the hash function(s) and/or hash table(s) to be used for the leaf node in question (for example, with the hash function(s) and/or hash table(s) being selected based on the region (volume) of storage associated with the leaf node, for example based on the level of detail at which the region (volume) of the scene (voxel(s)) represented by the leaf node is desired to be processed, for example based on the closeness of the region of the scene represented by the leaf node to a viewer (origin of viewing)).

When evaluating a hash function, the traversal unit may use any suitable and desired input (hash key). For example, the traversal unit may use an input (hash key) indicated in the leaf node (for example, corresponding to co-ordinates relevant to the leaf node volume). Alternatively, the traversal unit may determine an input (hash key) to be used based on the traversal performed (for example, based on the origin and direction of the traversal, for example to calculate a co-ordinate of interest to be used as an input (hash key)).

Thus, (as apparent from the above discussion), in embodiments, one or more leaf node types (including, for example, leaf nodes of a type comprising or pointing to voxel data, leaf nodes of a type indicating that a further data structure is to be traversed, leaf nodes of a type indicating that a hash is to be used to access voxel data), when encountered by the traversal unit, result in voxel data (indicating voxel properties) for one or more voxels being obtained from a region of storage (by the traversal unit). This voxel data is then used by the data processing system (a data processor) when performing processing relating to the scene. The processing performed by the data processor using the voxel data, as discussed above, may be any suitable and desired processing (for example rendering, or otherwise analysing the scene), for example according to a program which the data processor is executing (the program including the voxel traversal instruction that triggered the traversal).

However, the Applicant has recognised that where particular (for example non-standard) processing should be (is to be) performed (by the data processor) for voxel(s) falling within a region of the scene represented by a leaf node, then it is possible to specify the processing to be performed in the leaf node itself. Accordingly, in embodiments one or more leaf nodes may be of a type comprising an indication of a program to be executed (by the data processing system) for processing the voxel(s) occupying the volume associated with the leaf node.

In embodiments, the traversal unit is configured to, when a leaf node of a type (determined by the traversal unit to be of a type) comprising an indication of a program to be executed for processing the voxel(s) occupying the volume associated with the leaf node, inform (perform processing relating to one or more voxels comprising informing) the data processor of the program (for example all or part of the program, for example a sub-routine for the program) to be executed (by sending a message to the execution unit of the data processor).

In this regard, the leaf node may comprise, for example, a pointer to storage of the data processing system which stores a program (program instructions), or an identifier (ID) for a program to be executed. The traversal unit may communicate to the data processor (send in a message) the pointer to or identifier for the program to be performed. The data processor may then, execute the program accordingly.

The leaf node may also comprise data (a payload) to be processed using the program, the data in relating to voxel(s) falling within the leaf node volume. In this case, the traversal unit may also communicate to the data processor (send in a message) the leaf node payload.

It would be possible for the traversal unit to (always) communicate the pointer to or identifier for the program (and optionally any data (payload) for the program) to the data processor in response to encountering a leaf node of the type indicating a program to be performed, and in embodiments this is done.

Alternatively, in response to encountering a leaf node of the type indicating a program to be performed, the traversal unit may determine whether any voxel(s) falling within the volume represented by the leaf node are of interest (for example, are intersected, for example based on an origin and direction of interest used for traversing the hierarchal data) and should be processed according to the program, and (only) provide communicate the pointer to or identifier for the program (and optionally any data (payload) for the program) to the data processor when it is determined that one or more voxels are of interest (are intersected).

The data relating to one or more voxels that a leaf node comprises, may be (and in embodiment is) compressed, so as to facilitate storage of leaf node data in storage (e.g. local on-chip storage, or off-chip main memory) of the data processing system. Equally voxel data (indicating voxel properties) in storage may be compressed. The traversal unit may (thus) be capable of (configured to) handle (decompress, using a suitable decompression scheme) compressed data (as may be encountered during the operation of the traversal unit).

As discussed above, the operation of the traversal unit (to traverse a hierarchical data structure to obtain and handle data relating to voxel(s) of a scene) is triggered in response to an execution unit executing an instruction indicating that traversal is to be performed (a “voxel traversal instruction”). In this way, as discussed above, a traversal by the traversal unit may be triggered in response to a (single) instruction (“voxel traversal instruction”) incorporated into a program which is being executed by execution unit(s) of a data processor to perform processing relating to a scene represented by one or more voxels.

The technology described herein thus also extends the incorporation of such a “voxel traversal instruction” in a program to be executed.

Thus, in one embodiment, the technology described herein comprises a method of compiling a program to generate instructions for a data processor to perform processing relating to a scene represented by a set of one or more voxels;
the data processor comprising an execution unit operable to (configured to) execute instructions to perform data processing operations;
the data processor in communication with a traversal unit, for use when performing processing relating to a scene represented by a set of one or more voxels,
the traversal unit configured to traverse a hierarchical data structure representing a set of one or more voxels representing a scene, the hierarchical data structure comprising a plurality of nodes each associated with a respective volume within the scene, with one or more leaf nodes of the hierarchical data structure comprising data relating to one or more voxels that occupy the volume associated with the respective leaf node, to access data relating to one or more voxels representing the scene;
the method comprising:
including in the program to be executed an instruction indicating that a hierarchical data structure representing a set of one or more voxels representing a scene is to be traversed.

In another embodiment, the technology described herein comprises a compiler configured to compile programs to generate instructions for a data processor to perform processing relating to a scene represented by a set of one or more voxels;
the data processor comprising an execution unit operable to (configured to) execute instructions to perform data processing operations;
the data processor in communication with a traversal unit, for use when performing processing relating to a scene represented by a set of one or more voxels,
the traversal unit configured to traverse a hierarchical data structure representing a set of one or more voxels representing a scene, the hierarchical data structure comprising a plurality of nodes each associated with a respective volume within the scene, with one or more leaf nodes of the hierarchical data structure comprising data relating to one or more voxels that occupy the volume associated with the respective leaf node, to access data relating to one or more voxels representing the scene;
the compiler comprising a processing circuit configured to:
include in the program to be executed an instruction indicating that a hierarchical data structure representing a set of one or more voxels representing a scene is to be traversed.

The instruction indicating that a hierarchical data structure is to be traversed (the “voxel traversal instruction”), when executed an execution unit causes the execution unit to trigger operation of the traversal unit.

The instruction (“voxel traversal instruction”) may be configured in any suitable and desired way to support operation of the traversal unit.

For example, the instruction (“voxel traversal instruction”) may, and in embodiments does, include an indication of the origin and/or direction in which the scene is (is to be) viewed (corresponding to an origin and/or direction to be used by the traversal unit when traversing the hierarchical data structure).

In embodiments, the instruction (“voxel traversal instruction”) (also) indicates a level of detail at which the scene (the region of the scene to be viewed) is to be processed (for example based on the specified origin and/or direction). This indication may be used by the traversal unit to determine, when performing a traversal and encountering a leaf node which requires one or more further data structures to be traversed, which one or more data structure should be traversed. This indication may additionally (or alternatively) be used by the traversal unit to determine, when performing a traversal and encountering a leaf node which requires hash function(s) to be used to access voxel data from storage, which one or more hash function(s) and/or hash table(s) to use.

The indication of a level of detail at which the scene is to be processed, could be provided in any suitable and desired way, for example as a relative amount of detail required on a scale (from low detail, to high detail). Alternatively, the indication of a level of detail could comprise an explicit indication of which one or more further data structures should be traversed (in the event that the traversal unit encounters a leaf node requiring traversal of further data structure(s)) and/or an explicit indication of which one or more hash functions and/or hash tables should be used (in the event that the traversal unit encounters a leaf node requiring hash function(s) to be used to access voxel data from storage).

In embodiments, the instruction indicates whether the traversal unit is to delegate any processing (indicting which processing should be delegated by the traversal unit) to another component of the data processing system (for example to the data processor).

For example, the instruction may indicate that (in the event that the traversal unit encounters a leaf node requiring traversal of further data structure(s)), which further data structures are to be traversed should be determined by the data processor and/or indicate that the further data structure(s) are to be traversed by the data processor (for example by executing software).

As another example, the instruction may indicate that (in the event that traversal unit encounters a leaf node requiring hash function(s) to be used to access voxel data from storage) the hash functions and/or hash tables to be used are to be determined by the data processor, and/or that data processor is to evaluate (solve) the hash function(s) to identify the region of storage from which voxel data is to be obtained.

As will be appreciated by those skilled in the art, the compiler may be configured to compile a program consistent with (and the compilation process for compiling the program may be consistent with), and in combination with, any of the features of the technology described herein described herein, as appropriate.

Thus, the program in which the instruction (“voxel traversal instruction”) is provided (by the compiler) may be any suitable and desired program which is being compiled for execution by execution unit(s) of a data processor to perform processing relating to a scene represented by one or more voxels.

The processing to be performed relating to the scene may comprise, for example, rendering of the scene or analysis of the scene. Thus, the program being compiled may comprise one or more instructions which, when executed by the execution unit, cause processing to be performed for voxels of the scene, for example causing rendering operations and/or other analysis operations to be performed.

In embodiments, the “voxel traversal instruction” is provided in the program at an appropriate position in the sequence of instructions for the program, for accessing (when it is desired to obtain) data relating to voxels to be processed (the voxel data being obtained by way of a traversal by the traversal unit).

In embodiments, the compiler (compilation process) is configured to analyse a program to be to be executed (for example a program provided as higher-level code, e.g. by an application on a host processor (CPU) that requires data processing), to determine the instructions to be provided (and to determine when to insert, in the sequence of instructions, a “voxel traversal instruction”).

Thus, the compiler (compilation process) may be executed on a host processor (e.g. a CPU) of the data processing system (with the compiled program then being executed on suitable execution unit(s) of a data processor of the data processing system, such as the CPU, a graphics processor, or another processor). The compiler may be part of a driver for the relevant data processor (for example part of a driver for a graphics processor).

In embodiments, the compiler comprises a compiler circuit, comprising a programmable processing circuit that is appropriately programmed to perform the required compiler operation.

The compiler execution may be performed in advance of the instructions being required by the data processor (execution unit) for execution of the program, in an “offline” manner (in advance of runtime), or could be done “on-the-fly” at runtime.

The data processing system in accordance with the technology described herein (and operated in the manner of the technology described herein) can be any suitable and desired type of data processing system comprising a data processor operable to execute instructions.

The data processing system may be implemented, for example, as part of any suitable and desired electronic device, e.g., such as a desktop computer, a portable computing device (such as a laptop, mobile phone, tablet, wearable computing device, or other portable device), robotic device, automobile (e.g. car, or van, or other automobile) or a purpose-built computing device (for example, a computing device for use in medical or other scenarios). Thus, the technology described herein also extends to an electronic device that includes the data processing system of the technology described herein (and on which the data processing system operates in the manner of the technology described herein).

It would be possible to implement the data processing system as part of a computing system comprising plural electronic devices, e.g., such as a distributed computing system (such as a cloud computing system). However, in embodiments the data processing system (at least the data processor, and the traversal unit) is provided within a single electronic device (and not distributed across plural electronic devices).

In embodiments, the data processor and traversal unit are implemented as a system-on-chip (SoC) (for incorporation into an electronic device).

The data processing system of the technology described herein may comprise any suitable and desired components and elements that a data processing system can comprise (in addition to the data processor and traversal unit).

The data processing system in embodiments comprises a host processor (central processing unit (CPU)) operable to execute applications (for example an augmented reality, virtual reality, robotic navigation, or scene analysis application) which may require processing to be performed relating to a scene represented by one or more voxels. The host processor may comprise a compiler configured in the manner disclosed herein for generating program instructions to facilitate execution of processing for the application (by a programmable execution unit of a data processor, such as a graphics processor, or other data processor).

The data processing system may also comprise a display, for displaying information relating to the processing of the scene by the data processor (for example for displaying rendered image frames, or displaying information concerning the analysis of the scene, e.g. analysis results). The display could be any suitable and desired type of display, such as a screen or other display. A display processing unit (DPU) may be provided for controlling the display.

The data processing system may also comprise one or more environment sensors (for example, a camera, microphone, UV sensor, IR sensor, or other sensor), for detecting information relating to a ‘real-world’ environment (scene) to be represented using one or more voxels (to be “voxelized”).

The data processing system will also comprise storage for storing the data described herein and/or storing software for performing the processes described herein. This storage may comprise a main (off-chip) memory (e.g. SDRAM), and local (on-chip) storage (for example one or more caches, for example forming a cache hierarchy). The data processor (which is to perform processing relating to the scene represented by one or more voxels) may comprise and/or be in communication with any suitable and desired storage of the data processing system, for example as described herein.

The data processing system of the technology described herein may be implemented as part of any suitable system, such as a suitably configured micro-processor based system. In some embodiments, the technology described herein is implemented in a computer and/or micro-processor based system.

The various functions of the technology described herein may be carried out in any desired and suitable manner. For example, the functions of the technology described herein may be implemented in hardware or software, as desired. Thus, for example, the various functional elements of the technology described herein may comprise a suitable processor or processors, controller or controllers, functional units, circuits, processing logic, microprocessor arrangements, etc., that are operable to perform the various functions, etc., such as appropriately dedicated hardware elements (processing circuits) and/or programmable hardware elements (processing circuits) that can be programmed to operate in the desired manner.

It should also be noted here that, as will be appreciated by those skilled in the art, the various functions, etc., of the technology described herein may be duplicated and/or carried out in parallel on a given processor. Equally, the various processing circuits may share processing circuits, etc., if desired.

It will also be appreciated by those skilled in the art that all of the described embodiments of the technology described herein may include, as appropriate, any one or more or all of the features described herein.

The methods in accordance with the technology described herein may be implemented at least partially using software e.g. computer programs. It will thus be seen that when viewed from further embodiments the technology described herein comprises computer software specifically adapted to carry out the methods herein described when installed on data processor, a computer program element comprising computer software code portions for performing the methods herein described when the program element is run on data processor, and a computer program comprising code adapted to perform all the steps of a method or of the methods herein described when the program is run on a data processing system.

The technology described herein also extends to a computer software carrier comprising such software which when used to operate a data processing system causes in a processor, or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

A number of embodiments of the technology described herein will now be described.

As noted above, the technology described herein concerns a data processing system to be used for performing processing of a scene represented by one or more voxels.

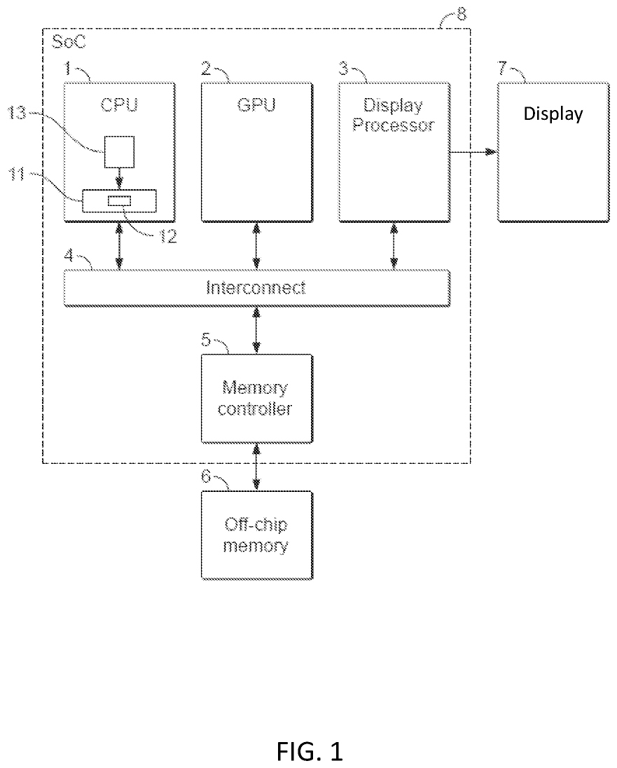

FIG. 1 shows an example data processing system in accordance with embodiments of the technology described herein.

The data processing system comprises data processors comprising a host processor in the form of a central processing unit (CPU) 1 and a graphics processor (GPU) 2 either or both of which may be used to perform processing for a scene represented by one or more voxels.

For example, the central processing unit 1 or graphics processor 2 could be used to perform scene analysis. The graphics processor 2 in particular may be used to perform rendering of a scene to produce frames (images) for display on a display 7 (the frames being provided to the display by a display processor 3). Other data processors not shown could also be provided, if desired, for example such as a neural engine, or other accelerators (which could also or instead by used to performed processing for the scene).

The system may be configured as a system-on-chip (SoC) 8, with the host processor 1, graphics processor 2 (and display processor 3) provided on a (same) chip, and operable to communicate via an interconnect 4. A memory controller 5 may also be provided to allow access to main, off-chip, memory 6 (for example, SDRAM).

In use of the data processing system, an application 13 (e.g. a game, augmented reality application, virtual reality application, or other application), executing on the host processor (CPU) 1 may require a scene to be processed (e.g. analysed, or rendered to provide a frame for display). The application 13 may provide commands in a high-level programming language, which are compiled (by a compiler 11 of the host processor) into program instructions for causing the desired processing to be performed.

When the processing is to be performed using the graphics processor 2 (e.g. comprises rendering), a driver 12 for the graphics processor 2 (which is executing on the host processor 1), may generate appropriate commands and data to be used by the graphics processor 2.

In the technology described herein, for a scene represented by one or more voxels which is to be processed, data for the voxels of the scene is accessed using a hierarchical data structure. Thus, in the technology described herein program instructions to be executed for performing processing of the scene will include one or more instructions which when executed cause a traversal of the hierarchical data structure to access voxel data.

In the technology described herein, the traversal of the hierarchical data structure to access voxel data is performed by a traversal unit (circuit) (hardware) of the data processing system, the traversal unit being specifically adapted to traverse the hierarchical data structure to access voxel data.

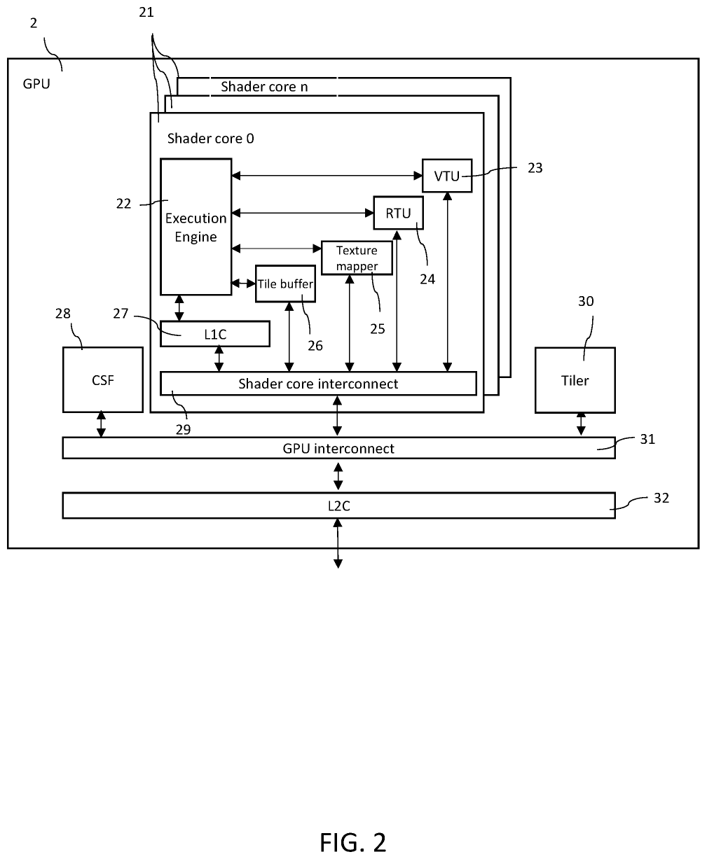

FIG. 2 illustrates an embodiment of the graphics processor (GPU) 2 of FIG. 1 in more detail, including a traversal unit 23 (voxel traversal unit “VTU”).

As shown in FIG. 2, the graphics processor 2 may comprise one or more processing cores 21 (shader core 0 to shader core n). The configuration of a single processing core 21 is shown, however each processing core 21 may have a similar configuration.

A (each) processing core 21 may comprise a programmable execution unit (circuit) (execution engine) 22 which is operable to execute instructions (for example, received for an application 13 executing on the host processor 1, via a driver 12), to perform data processing operations.

A (each) processing core 21 of the graphics processor 2 may comprise any suitable and desired components typically provided to facilitate performing graphics processing, for example a texture mapper 25, a tile buffer 26, and a ray tracing unit 24 (for performing ray tracing operations, such as traversing a ray tracing acceleration data structure and determining intersections of “rays” with primitives).

The components of (each) processing core 21 may have access to any suitable and desired storage, for example a cache hierarchy, for example comprising a level 1 cache 27 (integrated within the processing core 21), a level 2 cache 32 (external to the processing core), and the main off-chip memory of the data processing system.

Communication between components of a processing core 21, between processing cores 21, with other components of the graphics processor (not part of a shader core), and with storage, may be facilitated by one or more suitable interconnects, such as a shader core interconnect 29, and a GPU interconnect 31.

The graphics processor may also comprise (in addition to the processing cores 21) any suitable and desired other components for facilitating graphics processing, such as a command stream frontend (CSF) 28 (which may be operable to manage incoming work and distribute it among the processing cores 21), and a tiler 30 (when the graphics processor is operable to generate render outputs on a tiled basis).

In accordance with embodiments of the technology described herein, the graphics processor 2 is provided with a traversal unit (traversal circuit) 23 configured to traverse a hierarchical data structure to access data relating to a scene represented by one or more voxels.

The traversal unit 23 is in communication with the programmable execution unit 22, so that the execution unit can, in response to executing an instruction indicating that a traversal should be performed, cause a traversal by the traversal unit (by sending a message to the traversal unit to that effect).

In the embodiments shown, the traversal unit 23 is provided as part of the processing core 21 where the execution unit 22 resides, to allow direct communication between the execution unit and the traversal unit. However, the traversal unit could instead be provided externally to the processing core 21, or on another processing core 21.

In this regard, a single traversal unit 23 could be provided (for the graphics processor), and for example shared by plural shader cores (and triggered by plural different execution units). Alternatively, plural traversal units 23 could be provided, for example with one traversal unit 23 per processing core 21.

FIG. 2 shows the traversal unit 23 provided as distinct hardware unit, which does not share any circuit(s) with other components of the processing core, such as the ray tracing unit 24.

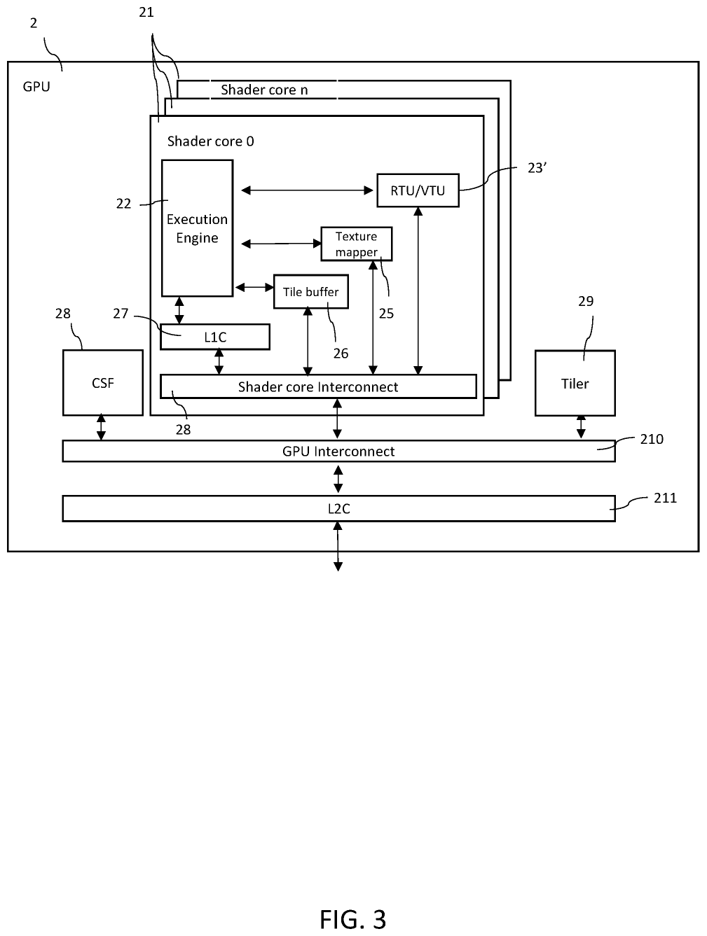

However, as discussed herein, and as illustrated in FIG. 3, it would be possible for the traversal unit to share (use) at least some circuit(s) of the ray tracing unit, so as to provide a combined ray tracing unit and traversal unit (voxel traversal unit VTU) 23′.

Whilst FIGS. 2 and 3 shows a traversal unit 23, 23′ provided for a graphics processor 2, it would equally be possible to provide traversal unit(s) for use by other data processors (such as a host processor, CPU, 1) in an analogous way. For example, in such embodiments, for a data processor (e.g. CPU) comprising a programmable execution unit operable to execute data processing operations, the execution unit may be in communication with a traversal unit 23 (for example, the traversal unit 23 and execution unit both provided within a same processing core), so that the execution unit in response to executing an instruction indicating that a traversal should be performed can trigger a traversal by the traversal unit 23.

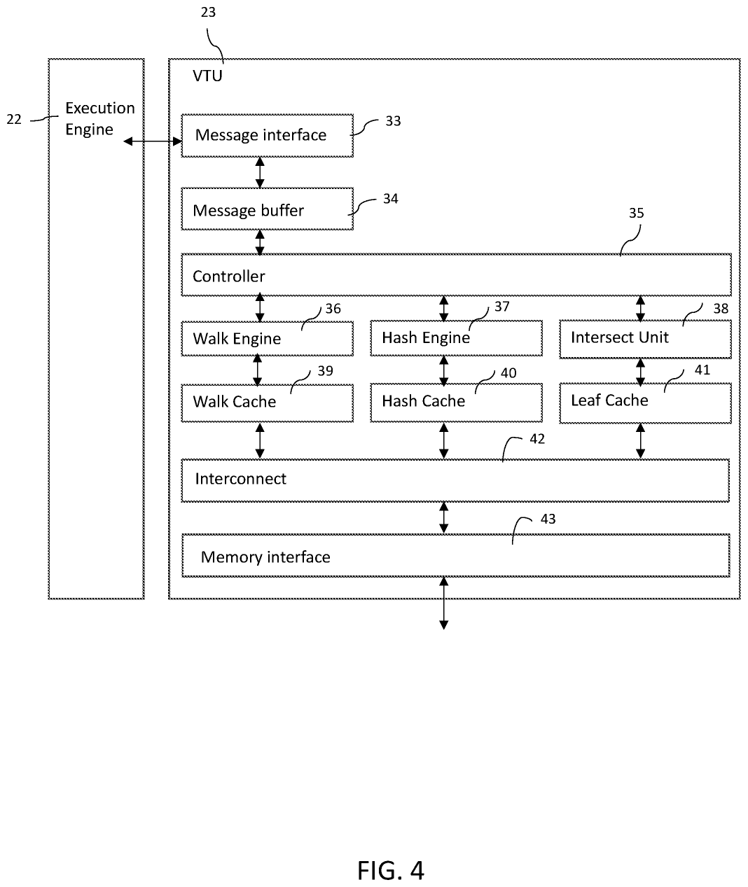

FIG. 4 shows in more detail a (voxel) traversal unit (VTU) 23 in embodiments of the technology described herein.

As illustrated in FIG. 4, the traversal unit 23 may comprise a message interface 33 for receiving messages from the execution unit 22, for example, the messages indicating that a traversal of a hierarchical data structure is to be performed (and for sending messages to the execution unit 22, for example communicating an outcome of, or an action to be performed in view of, a traversal which has been performed). The traversal unit 23 may also comprise a message buffer 34 for storing message data received from (or to be sent to) the execution unit 22.

The traversal unit 23 may also comprise a controller 35, for controlling the traversal unit 23 in response to incoming messages.

For example, the controller 35 may be operable to cause a walk unit (walk engine) 36 of the traversal unit 23 to walk (traverse) a hierarchical data structure.

In this regard, the traversal unit may comprise a (dedicated) walk unit 36 configured to walk (traverse) a hierarchical data structure until a leaf node is reached. The walk unit 36 may be in communication with a storage such as walk cache 39 for storing data retrieved or generated during the traversal of the hierarchical data structure.

The walk performed by the walk unit 36 (and walk cache 39) may be similar to a walk of a ray tracing acceleration data structure performed for a ray tracing operation, and so it would be possible for the walk unit 36 (and walk cache 39) to share circuits with an existing ray tracing unit of the graphics processor. Alternatively, the walk unit 36 (and walk cache 39) could be provided specifically for (and only as part of) the traversal unit 23 (and not share circuits with any existing ray tracing unit of the graphics processor).

The traversal unit may also comprise one or more other units (circuits) to assist with handling leaf nodes comprising data relating to one or more voxels (when they are encountered during a walk by the walk engine 36). These units (circuits) have functionality not found in a typical ray tracing unit and so are provided in addition to (and not share circuits with) any existing ray tracing unit. These units may include, an intersect unit 38 (with associated storage, leaf cache 41) configured to determine whether voxels for which data is provided in a leaf node are actually of interest (are intersected), and a hash unit 37 (with associated storage, hash cache 40) for handling leaf nodes indicating that a hash is to be used to access voxel data.

As discussed herein, in the technology described herein the traversal unit is caused to traverse a hierarchical data structure representing the scene represented by one or more voxels, to access voxel data.

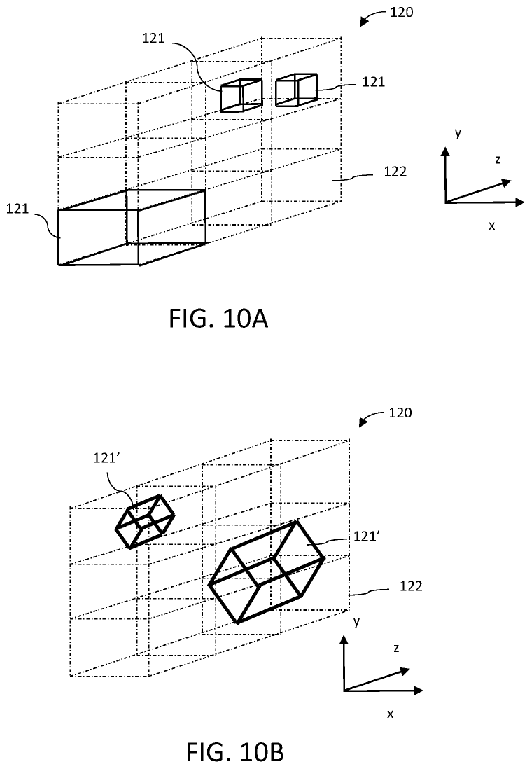

FIGS. 10A and 10B show example scenes 120 represented by one or more voxels 121, 121′, which may be represented by a hierarchical data structure and processed in the manner of the technology described herein.

The scene 120 may be any suitable and desired scene which is desired to be processed by a data processor, for example a virtual scene (e.g. to be displayed for a video game), or a scene which is based at least in part on a real-world scene (to be analysed or displayed, for example for an augmented reality application). The scene may have axes (corresponding to world axes), for example x, y and z axes as shown.

Elements (e.g. objects) in the scene may (each) be represented by one or more voxels 121, 121′.

A voxel, in this regard, is a three-dimensional volume, in an embodiment a cuboid- or cube-shaped volume. A voxel may have associated properties (such as colour, transparency, texture, movement vectors, size, coordinates, or other suitable and desired properties), as appropriate for the element (e.g. object) it represents.

One or more (or all) of the voxels 121 representing elements in the scene could be axis-aligned (so that their axis aligned with the x, y and z axes of the scene). However, it would also be possible for one or more of the voxels not to be axis-aligned, for example as shown for voxels 121′ in FIG. 10B. Non-axis-aligned voxels may be useful for representing elements (e.g. objects) in the scene which are not axis-aligned, e.g. are rotated (compared to the axes for the scene, as may be used when dividing the scene into volumes represented by nodes of the hierarchical data structure).

The voxels could all be the same size, or could differ in size (as illustrated). In this regard, the size of the voxels used for a particular region of the scene may depend on a resolution at which that region of the scene is represented (with larger voxels corresponding to a lower resolution, and smaller voxels corresponding to a higher resolution), and/or depend on the amount of storage assigned for (to be used for) storing that region of the scene (storing a greater number of smaller voxels uses more storage than a smaller number of larger voxels), and/or depend on the complexity of elements (objects) in that region of the scene.

For the purpose of storing voxel data for a scene, the scene can notionally be divided into a plurality of volumes 122 (for example as shown in FIGS. 10A and 10B). Data relating to any voxels 121, 121′ falling in a (respective) volume 122, can then be stored in a (respective) region of storage (e.g. in the main, off-chip, memory 5).

The volumes 122 could be configured (selected) (e.g. enforced) to include one or more voxels in their entirety (so as to form bounding volumes for the voxel(s) therein) (for example as shown in FIG. 10A). However, it would also be possible to permit voxels to span one or more volumes 122 (for example as shown in FIG. 10B).

The voxels of a scene may have different locations in space compared to one another (may fall within different volumes 122), and may have poor spatial locality (for example, if the elements they represent are not adjacent one another in the scene). In order to efficiently access voxel data from storage, a hierarchical data structure may be used.

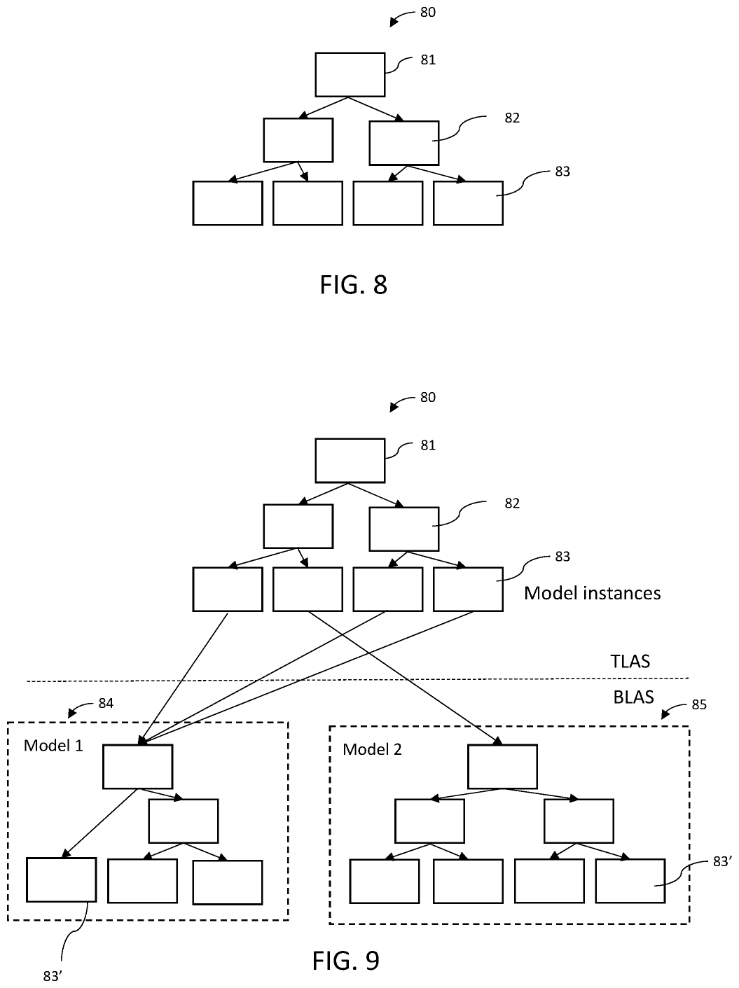

FIG. 8 shows an example hierarchical data structure 80 which can be used in embodiments of the technology described herein to represent a scene represented by one or more voxels.

The hierarchical data structure 80 comprises a plurality of nodes 81, 82, 83, each associated with a volume of the scene. The nodes may be arranged in a tree structure (as shown in FIG. 8), with a single root node (volume) 81 which encompasses (branches to) plural child nodes (volumes) 82, which in turn encompass (branch to) plural child nodes (volumes) 83, and so on. The nodes representing at the end of a branch, and having no child nodes, are “leaf nodes” 83.

Whilst the example of FIG. 8 shows each parent node having two child nodes, it would be possible to have other numbers of child nodes if desired (such as three, four, five, or six).

Whilst the example of FIG. 8 shows the hierarchical data structure having three hierarchical levels, more levels could be provided if desired, for example, with nodes 83 having child nodes, and so on until a leaf node is reached.

Each leaf node may represent a volume of the scene which is the same size, and which is axis aligned (for example, such as the volumes 122 shown in FIGS. 10A and 10B). However, it would also be possible for leaf nodes to represent volumes which are different sizes and/or are not axis aligned.

In the technology described herein, the leaf nodes of the hierarchical data structure are used for storing data relating to one or more voxels of the scene which fall within the volume associated with the respective leaf node.

As such, by traversing the hierarchical data structure (from the root node) to a leaf node associated with a volume (region) of interest of the scene, data relating to voxel(s) falling within that volume can be accessed.

It would be possible for a leaf node to simply contain voxel data indicating properties of the voxel(s) which fall within the volume associated with the leaf node (or a pointer to a storage location at which the properties of the voxel(s) are stored).

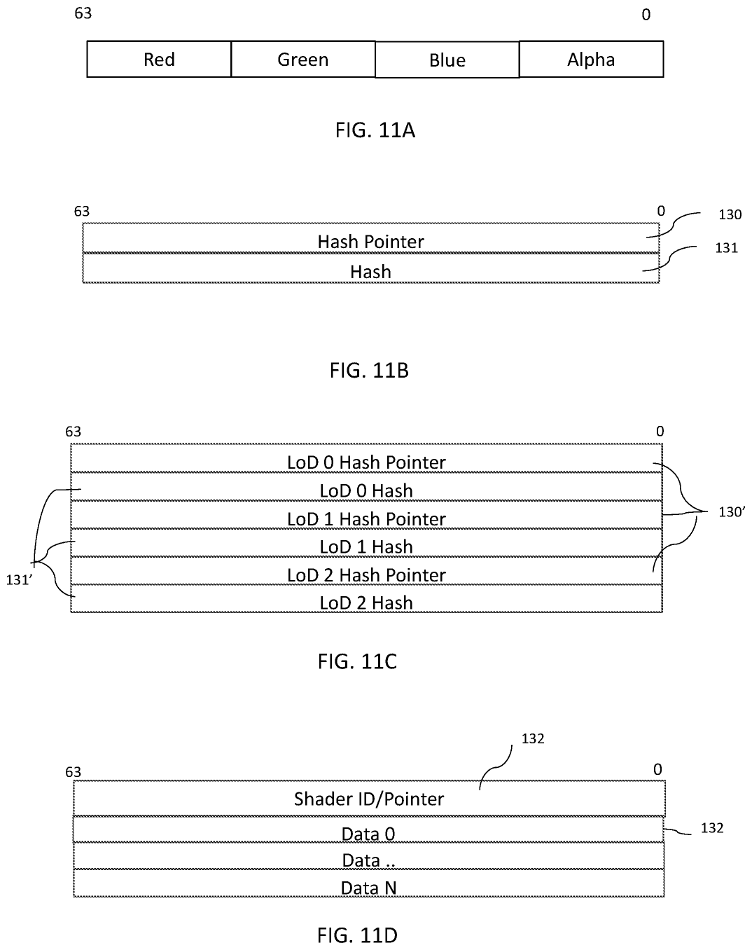

FIG. 11A shows example voxel data which may be stored in a leaf node (or in a storage location pointed to by a leaf node), which may comprise a colour of the voxel (for example in red, green, blue (RGB) format), and transparency (alpha). The voxel data could also comprise any other suitable and desired properties for the voxel, such as voxel coordinates (if the volume of the voxel differs from that associated with the leaf node), motion vector(s) for the voxel, or any other suitable and desired data.

In this regard, the hierarchical data structure could comprise leaf nodes of a single type (which comprise or point to voxel data).

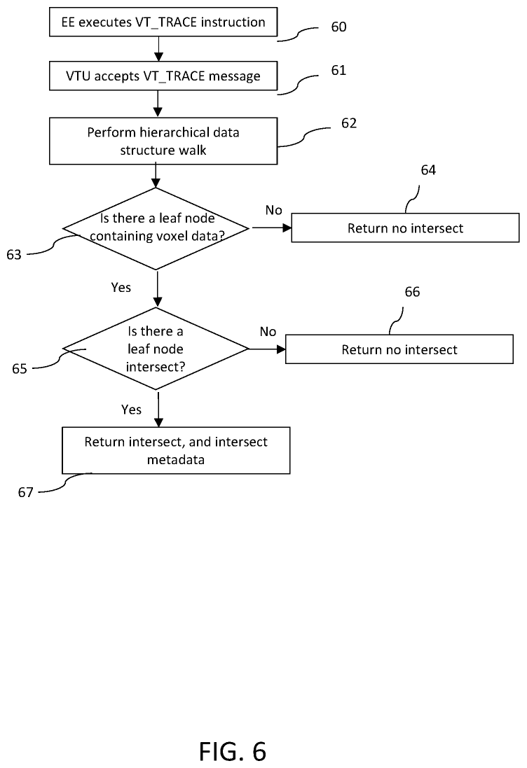

FIG. 6 is a flowchart showing operation of the data processing system of the technology described herein, for a hierarchical data structure comprising leaf nodes (only) of a type comprising voxel data.

With reference to FIG. 6, when a data processor is to perform processing relating to a scene represented by one or more voxels (by executing by its execution unit(s) 22 program instructions for an application running on the data processing system), an instruction may be provided (in the program instructions) indicating that a traversal of a hierarchical data structure representing the scene is to be performed (this instruction may be referred to herein as a “voxel traversal instruction”, or a “VT_TRACE instruction”).

In response to executing a VT_TRACE instruction (step 60), an execution unit (EE) 22 sends a message (VT_TRACE message) to the traversal unit (VTU) 23 indicating that a traversal of a hierarchical data structure representing the scene is to be performed.

The traversal unit (VTU) 23, in response to receiving the VT_TRACE message (step 61), then performs a traversal of a hierarchical data structure until a leaf node associated with a volume (region) of interest is reached (step 62). The traversal may be performed by the walk unit 36 of the traversal unit 23.

The volume (region) of interest in the scene may correspond, for example with a region of the scene which is being desired to be rendered for display (for example is currently, or expected to be, viewed, for example by a user in the case of an augmented reality application) or otherwise desired to be processed.

The traversal unit may traverse (walk) the hierarchical data structure in any suitable and desired manner to arrive at a leaf node associated with a volume (region) of interest of the scene. For example, the traversal may be performed based on an origin, direction (and optionally a range) to arrive at the region (volume) of interest in the scene. The walk may start at a first (root) node and test whether any volumes of its respective child nodes are of interest (are ‘intersected’ for the origin and direction for the traversal question), and then for any (child) node which was determined to be of interest (is intersected) to then determine whether any volume of its respective child nodes are of interest (are ‘intersected’), and so on until a leaf node is reached (or until the range into the scene is reached, if that occurs sooner). Such a walk may be performed in a similar way to a traversal of a ray tracing acceleration data structure, in which a ‘ray’ with an origin and direction is cast through the acceleration data structure.

Referring back to FIG. 6, when a leaf node is reached the traversal unit 23 may determine whether it contains voxel data for any voxels (step 63) (or points to a storage location comprising voxel data).

If the leaf node contains no voxel data (is empty) (or the leaf node contains no pointer to a region of storage, or the region of storage pointed to contains no voxel data), then the traversal unit 23 returns a message to the data processor (for example to the execution unit 22 thereof) indicating that there is no voxel to be processed (no intersect) (step 64). This may occur, for example if no voxels representing the scene fall within the leaf node volume.

If the leaf node contains (or points to a storage location containing) voxel data for one or more voxels (the voxel data indicating voxel properties), the traversal unit 23 determines whether any voxel is actually of interest (actually falls within a region of interest of the scene) (is ‘intersected’ based on the origin and direction used for the traversal) (step 65).

In this regard, as illustrated in FIG. 10A for example, a voxel 121 may not occupy the entire volume 122 associated with a leaf node, and so it is possible that a voxel is not actually intersected.

The determination of whether a voxel is actually intersected may be performed by the intersect unit 38 of the traversal unit 23. In this regard, any voxel data for the leaf may be loaded into the leaf cache 41 associated with the intersect unit 38, and used to determine whether an intersect occurs (for example, by comparing the coordinates and/or size of the voxel against the origin and direction used for the traversal, the determination optionally taking account of whether or not the voxel is axis-aligned)

If the voxel(s) for which voxel data is provided in the leaf node are determined not to be of interest (not intersected), then the traversal unit 23 returns a message to the data processor (for example to the execution unit 22 thereof) indicating that there is no voxel to be processed (no intersect) (step 66).

If a voxel for which voxel data is provided in the leaf node is determined to be of interest (are intersected), then the traversal unit 23 returns a message to the data processor (for example to the execution unit 22 thereof) indicating that there a voxel is be processed (an intersect has occurred) (step 67). This message may also contain metadata to be used when processing the voxel (for example comprising data or a pointer to the data required to process the voxel, such as the voxel data (properties) from the leaf node) (step 64).

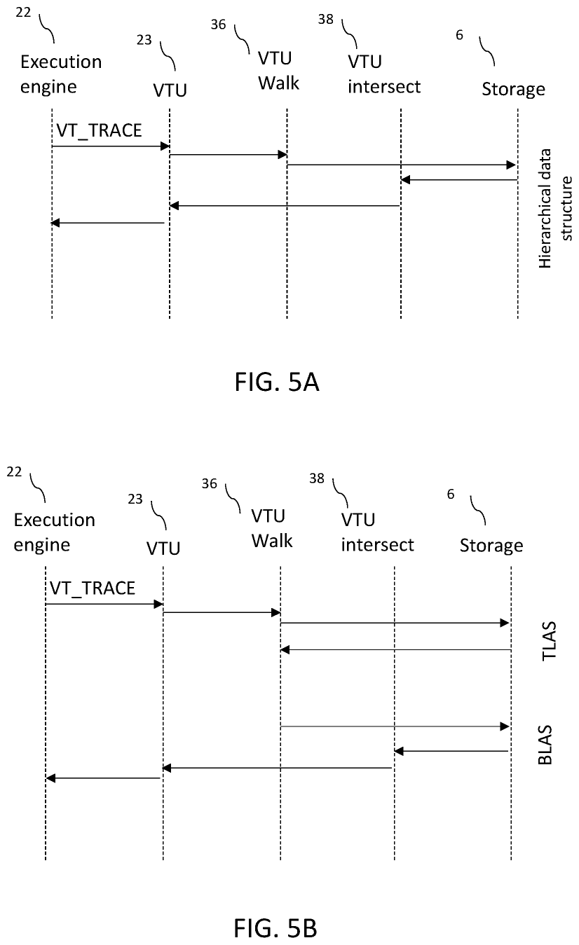

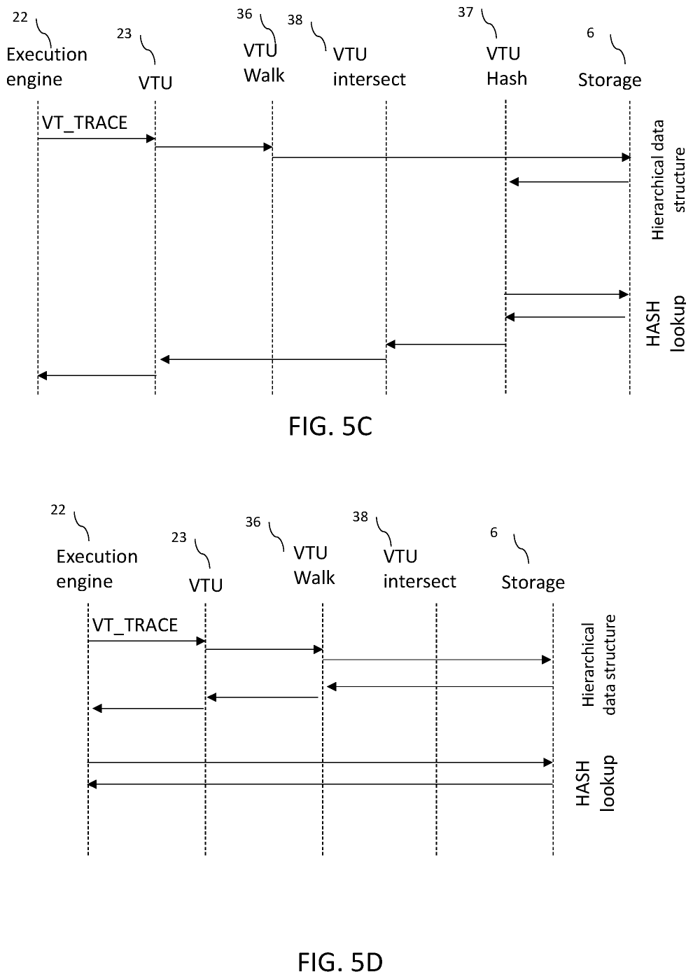

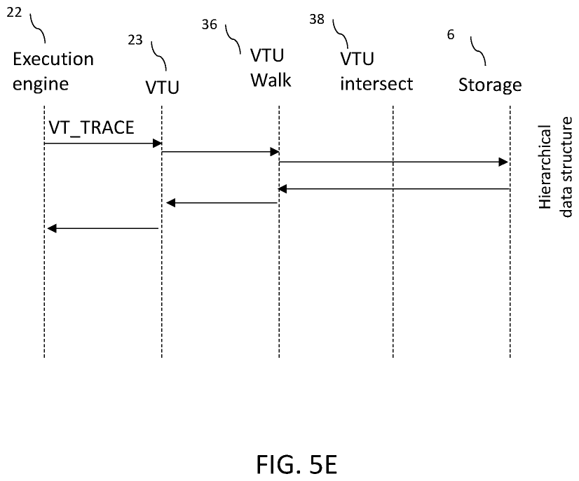

FIG. 5A is a diagram illustrating the various components of the data processing system which are used (and information flow therebetween) when the hierarchical data structure comprises leaf nodes (only) of a type comprising voxel data.

As shown in FIG. 5A, the execution unit 22 in response to executing an instruction indicating that a traversal is to be performed sends a message (VT_TRACE message) to the traversal unit (VTU) 23. The traversal unit 23 then performs a traversal of the hierarchical data structure using its walk unit 36.

When performing the traversal (walk), the walk unit 36 tests whether node volumes of the hierarchical data structure are intersected (according to the origin and direction for the walk as discussed above). Information identifying the volumes associated with nodes of the hierarchical data structure may be obtained by the walk unit 36 (and stored in walk cache 39) as and when required from storage of the data processor (such as from main memory 6, for example obtained via appropriate interconnects and cache hierarchy discussed with respect to FIGS. 1 to 4).

When the walk unit 36 reaches a leaf node, the leaf node data (comprising voxel data indicating voxel properties) is sent to the intersect unit 38 of the traversal unit 23, which determines whether a voxel falling within the leaf node volume is actually of interest (is actually intersected). If the voxel is determined to be intersected, the traversal unit 23 informs the execution unit 22 that the voxel is to be processed.

Whilst it would be possible for the hierarchical data structure to be configured with leaf nodes only of the type which can contain voxel data (or a pointer to a storage location containing voxel data), as discussed above the Applicant has recognised that it may be advantageous to also allow (and handle) leaf nodes containing other types of data.

For example, and in embodiments the hierarchical data structure may also be configured with (allow) leaf node(s) of a type which require a further data structure to be traversed.

An example such situation is shown in FIG. 9, in which, upon reaching a leaf node 83 of the hierarchical data structure 80 (which forms a top level acceleration data structure (TLAS)), a further hierarchical data structure 84, 85 (forming a bottom level acceleration data structure (BLAS)) is required to be traversed (in order to arrive at a leaf nodes 83′ comprising voxel data).

Such a further hierarchical data structure could be used, for example, to navigate a model space of an element (e.g. object) of the scene to determine properties of one or more voxels representing at least part of the element (e.g. object). There may be multiple different further hierarchical data structures 84, 85 available for use, for example representing the different instances of the element (object), for example at different levels of detail.

In such embodiments, a leaf node 83 of the hierarchical data structure 80 may indicate that a further hierarchical data structure 84, 85 is to be traversed.

The traversal unit, upon reaching a leaf node 83 may determine whether a further hierarchical data structure is to be used (for example based on an indication in the leaf node). The traversal unit may also determine which further hierarchical data structure 84, 85 to use. The determination of which further hierarchical data structure 84, 85 to use could be based on an indication in the leaf node of which further hierarchical data structure 84, 85 to use. Alternatively, it could be based on a (desired) level of detail for processing the region of the scene represented by the leaf node. For example, the desired level of detail could be indicated in the VTU_trace instruction executed by the execution unit and communicated to the traversal unit in the VTU_trace message. Alternatively, the traversal unit could for example determine the desired level of detail based on the closeness of the leaf node volume (and voxel(s)) to the origin of viewing the scene (as used for the traversal).

The traversal unit may then traverse the appropriate further hierarchical data structure 34, 85, to arrive at a leaf node 83′.

Alternatively, there may be a single hierarchical data structure used (and no further hierarchical data structure(s), thus no division into a TLAS and BLAS), for example as shown in FIG. 8.

The leaf node 83′ may comprise voxel data (or a pointer to a storage location storing voxel data) (such as described above with respect to leaf nodes 83), or could comprise or other types of data relating to voxel(s) falling within the leaf node 83′ volume, such as hash data or an indication of a software program to be performed to process voxels, as will be described herein. The traversal unit may then trigger appropriate processing of voxels for which voxel data is found.

FIG. 5B is a diagram illustrating the various components of the data processing system which are used (and information flow therebetween) when a hierarchical data structure and a further hierarchical data structure are traversed.

Similarly to FIG. 5A, the execution unit 22 sends a message (VT_TRACE message) to the traversal unit (VTU) 23, which performs a traversal of the (first) hierarchical data structure (top level acceleration data structure (TLAS)) using its walk unit 36, and accessing data from storage 6 as and when needed for the walk.

However, as shown in FIG. 5B upon reaching a leaf node and determining that a further hierarchical data structure (bottom level acceleration data structure (BLAS)) is to be traversed, the walk unit 36 then traverses the relevant BLAS, until a leaf node 83′ is reached.

If the leaf node 83′ comprises voxel data indicating voxel properties (is not empty), the intersect unit 38 determines whether a voxel falling within the leaf node volume is actually of interest (is actually intersected), and if there is an intersect informs the execution unit 22 that the voxel is to be processed.

Another type of leaf node 83 which may be encountered (which may be used in the hierarchical data structure of the technology described herein) is a leaf node comprising hash data (comprising an indication that a hash function is to be used to access voxel data).

Using a hash may provide a particularly fast and efficient way of accessing a region of storage containing data related to voxels.

Example leaf nodes of a type comprising hash data are shown in FIGS. 11B and 11C.

As shown in FIG. 11B, the leaf node may comprise an indication of storage (e.g. a buffer) storing data relating to one or more voxels (“hash pointer” 130), and a (single) hash function (hash 131) to be used to determine a region of said storage from which to access voxel data.

Alternatively, as shown in FIG. 11C, the leaf node may indicate plural hash functions 131′ be used for respective storage (e.g. buffers) (as indicated by hash pointers 130′).

The traversal unit, when performing a traversal of the hierarchical data structure and encountering a leaf node comprising hash data, may solve one or more (or all) of the indicated hashes to identify a region of storage from which voxel data is to be accessed. In this regard, solving a hash may comprise evaluating a hash function 131, 131′ based on a suitable input (hash key) to determine an output (hash value) indicative of a region of the storage (pointed to by pointer 130, 130′) from which voxel data is to be accessed (the hash value, for example comprising an index which maps to a region of storage according to a hash table).

The input (hash key) to be used could also be provided in the leaf node. Alternatively or additionally it may be determined by the traversal unit based on the traversal (e.g. the origin and direction of the traversal) being performed. The input (hash key) may be based on (for example comprise) co-ordinates relevant to the leaf node volume and/or relevant to the traversal (for example based on the origin and direction of the traversal).

The leaf node may indicate plural hash functions for accessing voxel data stored at different levels of detail in storage. In this case, the traversal unit may select a (single) hash function to use (and storage to be searched, as indicated by a pointer in the leaf node) based on the level of detail at which voxels for the region of the scene represented by the leaf node are desired to be processed.

(As discussed above, the desired level of detail could be indicated in the VTU_trace instruction executed by the execution unit and communicated to the traversal unit in the VTU_trace message, or could be determined by the traversal unit for example based on the closeness of the leaf node volume (and voxel(s)) to the origin of viewing the scene (as used for the traversal)).

It would also be possible for the traversal unit to solve plural hash functions so as to ‘walk’ a hash hierarchy. For example, the traversal unit could solve (walk) each the hash functions at level of detail (LoD) 0, 1, 2 etc., in turn (to an appropriate level of detail). For example, the traversal unit may determine for a first level of detail whether a region of storage determined using the hash function stores voxel data (whether there is a ‘hit’), and if there is a hit determine whether voxel data is stored at the next (higher) level of detail (in a region determined using the hash function for the next level of detail), and so on for successive levels of detail.

Whilst FIGS. 11B and 11C show leaf nodes indicating the hash functions 131, 131′ to be used, this could be omitted. In this case, the traversal unit may determine which hash function(s) to use, for example using a known, e.g. predetermined, hash function.

FIG. 5C is a diagram illustrating the various components of the data processing system which are used (and information flow therebetween) when leaf node containing hash data is encountered.

Similarly to FIG. 5A, the execution unit 22 sends a message (VT_TRACE message) to the traversal unit (VTU) 23, which performs a traversal of a hierarchical data structure using its walk unit 36, and accessing data from storage 6 as and when needed for the walk.

However, as shown in FIG. 5C upon reaching a leaf node and determining that it contains hash data, the hash unit 37 then solves the relevant hash function(s) to identify a region of storage from which data relating to one or more voxels is to be obtained. The data relating to one or more voxels is obtained from storage 6 and (if it contains voxel data indicating voxel properties (is not empty)) is processed by the intersect unit 38 to determine whether a voxel is actually of interest (is intersected), and if there is an intersect the execution unit 22 is informed that the voxel is to be processed.

Whilst it would be possible for the hash unit of the traversal unit to evaluate hash function(s) to identify a region of storage from which data relating to one or more voxels is to be obtained, it would additionally or alternatively be possible for the data processor (GPU) 21 to do this (for example, by executing a software program), and in embodiments this is done.

The various components of the data processing system which are used (and information flow therebetween) in this case is illustrated in FIG. 5D. In this case, the traversal unit (walk unit 36) upon reaching a leaf node and determining that it contains hash data, returns a message to the execution unit 22 of the data processor 21 indicating that data for the voxel(s) falling within the leaf node volume is to be accessed using one or more hash functions (for example, by sending the hash data from the leaf node to the execution unit). The data processor (execution unit 22) then evaluates one or more hash functions to identify a region of storage from which data relating to one or more voxels is to be obtained.

In this case, the data relating to one or more voxels may be obtained from storage by the data processor (execution unit 22) and processed. Alternatively, the data processor (execution unit 22) may communicate the data relating to one or more voxels to the traversal unit 23 for the intersect unit 28 to determine whether any voxel is actually of interest (is intersected).

Another type of leaf node 83 which may be encountered (which may be used in the hierarchical data structure of the technology described herein) is a leaf node comprising an indication of a program to be executed for processing voxel(s) occupying the volume associated with the leaf node.

An example leaf node of this type is shown in FIG. 11D. In this case, the leaf node may comprise a pointer to storage storing the program (program instructions) (for example a shader program), or an identifier (ID) for a program to be executed. The leaf node may also comprise data (a payload) to be processed using the program (Data 0 to N) 132.

FIG. 5E is a diagram illustrating the various components of the data processing system which are used (and information flow therebetween) when leaf node containing indication of a program to be executed is encountered.

Similarly to FIG. 5A, the execution unit 22 sends a message (VT_TRACE message) to the traversal unit (VTU) 23, which performs a traversal of a hierarchical data structure using its walk unit 36, and accessing data from storage 6 as and when needed for the walk.

However, as shown in FIG. 5E upon reaching a leaf node and determining that it contains an indication of a program to be executed, the traversal unit sends a message to the execution unit 22 of the data processor indicating the program which is to be executed (the message, for example, including the pointer to storage storing the program or the program identifier, along with the payload), and the execution unit then executes the program accordingly.

Thus, it will be appreciated that the data processing system of the technology described herein may be configured to handle various different types of leaf node containing data relating to voxel(s) of a scene.

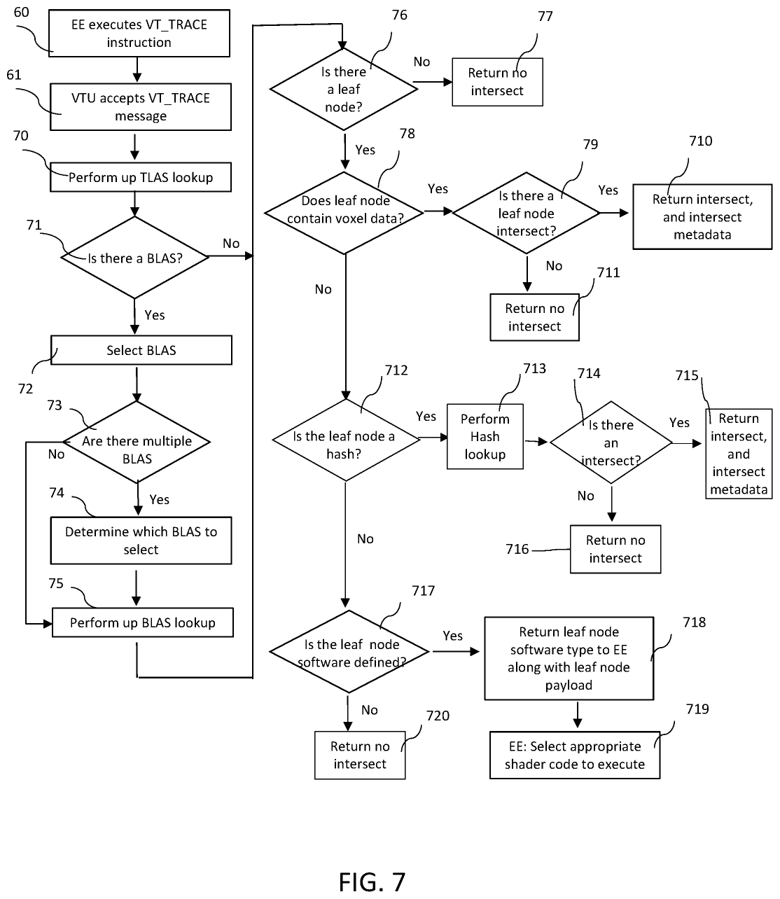

FIG. 7 provides an overall flowchart of the processing performed in the case that multiple different types of leaf node are used.

Similarly to FIG. 6, in response to the execution unit executing a VT_TRACE instruction (step 60), the execution unit (EE) 22 sends a message (VT_TRACE message) to the traversal unit (VTU) 23 indicating that a traversal of a hierarchical data structure representing the scene is to be performed.

The traversal unit (VTU) 23, in response to receiving the VT_TRACE message (step 61), then performs (using the walk unit 36) a traversal of a (first) hierarchical data structure until a leaf node associated with a volume (region) of interest is reached (step 70).

If the leaf node indicates that a further data structure (BLAS) is to be traversed (step 71), then the traversal unit selects the further data structure (BLAS) to be traversed (step 72). This may comprise selecting from multiple possible further data structures (step 73, and step 74). The traversal unit (walk unit 36) then traverses the selected further data structure (step 75) until a leaf node is reached.

If the leaf node reached (at the end of the traversal of the initial hierarchical data structure (TLAS) in the case of no further traversal being required, or at the end of the traversal of the further data structure (BLAS) if required) contains no data relating to voxels (is empty) (step 76) then the traversal unit sends a message to the execution unit indicating that no voxel is to be processed (step 77, return no intersect).

If the leaf node is not empty and contains (or points to a memory location storing) voxel data (indicating voxel properties) (step 78), then the traversal unit (intersect unit 38) determines whether the voxel(s) for which voxel data is provided are of interest (are intersected). If a voxel is intersected, the traversal unit sends a message to the execution unit indicating that the voxel is to be processed (and sends to the execution unit any voxel data needed for the voxel to be processed) (step 710). The traversal unit may take account of whether the voxel intersected is (at least partially) transparent, and if so for example perform further tests for intersections with other voxels. If no voxel is intersected, then traversal unit sends a message to the execution unit indicating that no voxel is to be processed (step 711).

If the leaf node instead contains hash data (step 712), then the traversal unit (hash unit 37) performs a hash lookup (evaluates one or more hash functions based on hash key(s) indicated in the leaf node, to identify a region of stored from which to access voxel data) (step 713). If voxel data (indicating voxel properties) is found in the identified region of storage for one or more voxels, then the traversal unit (intersect unit 38) determines whether any of those voxel(s) are of interest (are intersected) (step 714). If a voxel is intersected, the traversal unit sends a message to the execution unit indicating that the voxel is to be processed (and sends any voxel data needed for the voxel to be processed) (step 710). If no voxel is intersected, then traversal unit sends a message to the execution unit indicating that no voxel is to be processed (step 711).

If the leaf node instead contains an indication of a program to be executed for processing voxel(s) occupying the volume associated with the leaf node (step 717) (such that the leaf node is software defined), then the traversal unit sends a message to the execution unit indicating the program (for example indicating the ID of the program, or a pointer to the program) which is to be executed along with any data in the leaf node for performing the execution (the payload) (step 718), and the execution unit then executes the program accordingly (step 718).

If the leaf node is empty (contains no data relating to voxel(s), for example of any of the types described herein), then the traversal unit sends a message to the execution unit indicating that no voxel is to be processed (step 720).

As set out above, the technology described herein provides methods and systems for processing a scene represented by one or more voxels.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

What is claimed is:

1. A method of operating a data processing system when performing processing relating to a scene represented by a set of one or more voxels, the data processing system comprising:
a data processor, the data processor comprising an execution unit operable to execute instructions to perform data processing operations; and
a traversal unit, for use when performing processing relating to a scene represented by a set of one or more voxels,
the traversal unit configured to traverse a hierarchical data structure representing a set of one or more voxels representing a scene, the hierarchical data structure comprising a plurality of nodes each associated with a respective volume within the scene, with one or more leaf nodes of the hierarchical data structure comprising data relating to one or more voxels that occupy the volume associated with the respective leaf node, to access data relating to one or more voxels representing the scene; and
the method comprising:
the execution unit, in response to executing an instruction indicating that a hierarchical data structure representing a set of one or more voxels representing a scene is to be traversed, causing the traversal unit to traverse the hierarchical data structure; and
the traversal unit, when traversing the hierarchical data structure, when a leaf node is encountered containing data relating to one or more voxels, triggering processing relating to said one or more voxels.

2. The method of claim 1, wherein the hierarchical data structure is permitted to comprise plural types of leaf node, comprising different types of information relating to one or more voxels.

3. The method of claim 1, wherein the data relating to one or more voxels which is provided in a leaf node comprises one or more of: voxel data or a pointer to a region of storage storing voxel data; an indication that a further data structure is to be traversed to obtain voxel data; hash data; or an indication of a program to be executed.

4. The method of claim 1, wherein a leaf node is permitted to comprise data relating to one or more voxels which are not axis aligned.

5. The method of claim 1, wherein the traversal unit, in response to encountering a leaf node comprising data relating to one or more voxels comprising voxel data or a pointer to a region of storage storing voxel data, informs the data processor whether said one or more voxels should be processed.

6. The method of claim 1, wherein the traversal unit, in response to encountering a leaf node indicating that a further data structure is to be traversed, traverses a further data structure until a leaf node of the further data structure is encountered, and informs the data processor whether one or more voxels for which data is provided in the leaf node which should be processed.

7. The method of claim 1, wherein the traversal unit, in response to encountering a leaf node comprising hash data, solves one or more hash functions to determine a region of storage from which to access voxel data.

8. The method of claim 1, wherein the traversal unit, in response to encountering a leaf node comprising an indication of a program to be executed, informs the data processor of the program or part of the program to be executed.

9. The method of claim 1, wherein the traversal unit is formed at least in part of a ray tracing unit of a graphics processor of the data processing system.

10. The method of claim 1, wherein the processing relating to the scene performed by the data processor comprises rendering.

11. A data processing system configured to perform processing relating to a scene represented by a set of one or more voxels, the data processing system comprising:
a data processor, the data processor comprising an execution unit operable to execute instructions to perform data processing operations; and
a traversal unit, for use when performing processing relating to a scene represented by a set of one or more voxels,
the traversal unit configured to traverse a hierarchical data structure representing a set of one or more voxels representing a scene, the hierarchical data structure comprising a plurality of nodes each associated with a respective volume within the scene, with one or more leaf nodes of the hierarchical data structure comprising data relating to one or more voxels that occupy the volume represented by a respective leaf node, to access data relating to one or more voxels representing the scene;
wherein the execution unit is configured to, in response to executing an instruction indicating that a hierarchical data structure representing a set of one or more voxels representing a scene is to be traversed, cause the traversal unit to traverse the hierarchical data structure; and
the traversal unit is configured to, when traversing the hierarchical data structure, when a leaf node is encountered containing data relating to one or more voxels, trigger processing relating to said one or more voxels.

12. The data processing system of claim 11, wherein the traversal unit is configured to handle plural different types of leaf node, comprising different types of information relating to one or more voxels.

13. The data processing system of claim 11, wherein the data relating to one or more voxels which is provided in a leaf node is permitted to comprise one or more of: voxel data or a pointer to a region of storage containing voxel data; an indication that a further data structure is to be traversed to obtain voxel data; hash data; or an indication of a program to be executed.

14. The data processing system of claim 11, wherein the traversal unit is configured to, in response to encountering a leaf node comprising data relating to one or more voxels which comprises voxel data or a pointer to a region of storage containing voxel data, inform the data processor whether said one or more voxels should be processed.

15. The data processing system of claim 11, wherein the traversal unit is configured to, in response to encountering a leaf node indicating that a further data structure is to be traversed, traverse a further data structure until a leaf node of the further data structure is encountered, and inform the data processor whether one or more voxels for which data is provided in the leaf node should be processed.

16. The data processing system of claim 11, wherein the traversal unit comprises a hash unit configured to, when the traversal unit encounters a leaf node comprising hash data, solve one or more hash functions to determine a region of storage from which to access voxel data.

17. The data processing system of claim 11, wherein the traversal unit is configured to, in response to encountering a leaf node comprising an indication of a program to be executed, inform the data processor of the program or part of the program to be executed.

18. The data processing system of claim 11, wherein the traversal unit is formed at least in part of a ray tracing unit of a graphics processor of the data processing system.

19. The data processing system of claim 11, wherein the data processor is a graphics processor.

20. A method of compiling a program to generate instructions for a data processor to perform processing relating to a scene represented by a set of one or more voxels;
the data processor comprising an execution unit operable to execute instructions to perform data processing operations;
the data processor in communication with a traversal unit, for use when performing processing relating to a scene represented by a set of one or more voxels,
the traversal unit configured to traverse a hierarchical data structure representing a set of one or more voxels representing a scene, the hierarchical data structure comprising a plurality of nodes each associated with a respective volume within the scene, with one or more leaf nodes of the hierarchical data structure comprising data relating to one or more voxels that occupy the volume associated with the respective leaf node, to access data relating to one or more voxels representing the scene;
the method comprising:
including in the program to be executed an instruction indicating that a hierarchical data structure representing a set of one or more voxels representing a scene is to be traversed.

21. A non-transitory computer readable storage medium storing computer software code which when executing on at least one processor performs a method of operating a data processing system when performing processing relating to a scene represented by a set of one or more voxels, the data processing system comprising:
a data processor, the data processor comprising an execution unit operable to execute instructions to perform data processing operations; and
a traversal unit, for use when performing processing relating to a scene represented by a set of one or more voxels,
the traversal unit configured to traverse a hierarchical data structure representing a set of one or more voxels representing a scene, the hierarchical data structure comprising a plurality of nodes each associated with a respective volume within the scene, with one or more leaf nodes of the hierarchical data structure comprising data relating to one or more voxels that occupy the volume associated with the respective leaf node, to access data relating to one or more voxels representing the scene; and
the method comprising:
the execution unit, in response to executing an instruction indicating that a hierarchical data structure representing a set of one or more voxels representing a scene is to be traversed, causing the traversal unit to traverse the hierarchical data structure; and
the traversal unit, when traversing the hierarchical data structure, when a leaf node is encountered containing data relating to one or more voxels, triggering processing relating to said one or more voxels.
